(19) United States
(12) Patent Application Publication
(10) Pub. No.: US 2026/0242521 A1
(43) Pub. Date: Aug. 20, 2026

(54) RADICAL POLYMERIZABLE COMPOSITION AND POLYMERIZED PRODUCT THEREOF

(71) Applicant: NIPPON SHOKUBAI CO., LTD., Osaka-shi, Osaka (JP)

(72) Inventors: Tomomasa KANEKO, Osaka (JP); Ryosuke INUBUSHI, Osaka (JP); Susumu HIRAMA, Osaka (JP)

(21) Appl. No.: 18/871,383

(22) PCT Filed: Jun. 9, 2023
(86) PCT No.: PCT/JP2023/021512

§ 371 Date: Dec. 3, 2024

(30) Foreign Application Priority Data
Jun. 10, 2022 (JP) 2022-094054

(51) Int. Cl. C08F 220/06

(52) U.S. Cl. CPC C08F 220/06

(57) ABSTRACT

The present invention aims to provide a radically polymerizable composition that is in a liquid state and can easily form a resin having an ionomer structure. The present invention relates to a radically polymerizable composition containing: a water-immiscible radically polymerizable compound (A); and an anion represented by the following formula (1):

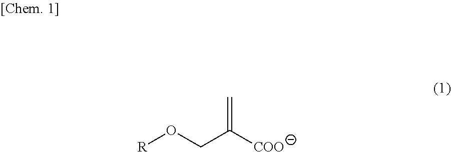

wherein R represents a saturated or unsaturated hydrocarbon group having 10 or less carbon atoms. The anion is contained in a ratio of 1 to 120 parts by mass per 100 parts by mass of the water-immiscible radically polymerizable compound (A).

### TECHNICAL FIELD

The present invention relates to a radically polymerizable composition and a polymer thereof.

### BACKGROUND ART

Ionomers are basically resins in which hydrophobic host polymers are crosslinked with ions, and many types of ionomers have been developed. Examples of typical ionomers include ethylene ionomers, styrene ionomers, perfluorocarbon ionomers, telechelic ionomers, and polyurethane ionomers. Ionomers are synthesized by synthesizing host polymers having ionizable functional groups and then ionizing (neutralizing) the host polymers (Non-Patent Literature 1, pp. 2-6).

Among ionomers, in particular, ethylene ionomers are materials most practically used in industry. They are resins in which the molecules of copolymers of ethylene and an unsaturated carboxylic acid such as a (meth)acrylic acid are ionically crosslinked via metal ions such as sodium and zinc ions or amines. Unlike covalently crosslinked resins, ethylene ionomers are known to have thermoplasticity in spite of being a crosslinked resin and to exhibit a variety of excellent properties including transparency, toughness, abrasion resistance, low temperature resistance, solvent resistance, heat sealability, adhesion, and self-repairing properties (see, for example, Non-Patent Literature 1 (p. 171), Non-Patent Literature 2, Patent Literatures 1 to 3).

### CITATION LIST

### Patent Literature

Patent Literature 1: JP 2016-079408 A
Patent Literature 2: JP 2005-054019 A
Patent Literature 3: JP H11-029672 A

### Non-Patent Literature

Non-Patent Literature 1: “Development of Ionomer and Ion Containing Polymer”, CMC Publishing Co., Ltd., 2009 Non-Patent Literature 2: Journal of the Robotics Society of Japan, Vol. 24, No. 4, p. 442, 2006

### SUMMARY OF INVENTION

### Technical Problem

As described above, ethylene ionomers are known to be obtained by copolymerizing ethylene and unsaturated carboxylic acid and ionizing the resulting copolymer.

Resins such as conventional ionomers synthesized by synthesizing host polymers having ionizable functional groups and then ionizing (neutralizing) the host polymers are poorly soluble in common organic solvents and are difficult to form liquid compositions.

Monomers widely used as highly radically polymerizable carboxylates include metal salts of (meth)acrylic acid. These are miscible only with water or highly polar organic substances and cannot be homogeneously dissolved in less polar vinyl compounds and cannot be formed into a liquid state easily.

Further, non-ionic polyfunctional vinyl compounds such as polyfunctional (meth)acrylic acid esters used as monomers can be homogeneously dissolved in less polar vinyl compounds to form crosslinked polymers. However, the crosslinks are covalent, and it is difficult to achieve the properties seen in ionomers, such as thermoplasticity.

In response to these, the present invention aims to provide a radically polymerizable composition that is in a liquid state, can easily form a resin having an ionomer structure, and can be applied to, for example, various printing applications.

### Solution to Problem

The present inventors have conducted various investigations to achieve the above object and have arrived at the present invention. In other words, the object of the present invention is achieved by the following [1] to [4].
[1] A radically polymerizable composition containing:
a water-immiscible radically polymerizable compound (A); and
an anion represented by the following formula (1):

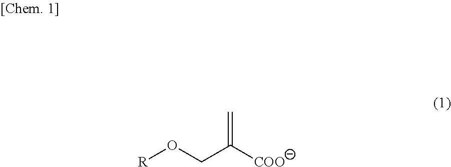

wherein R represents a saturated or unsaturated hydrocarbon group having 10 or less carbon atoms,
the anion being contained in a ratio of 1 to 120 parts by mass per 100 parts by mass of the water-immiscible radically polymerizable compound (A).
[2] The radically polymerizable composition according to [1],
wherein R in the formula (1) is an allyl group or a methallyl group.
[3] The radically polymerizable composition according to [1] or [2], further containing a cation,
wherein the cation includes one or more cations selected from the group consisting of metal ions, metal oxide ions, and cations containing non-metallic elements of Group 15 of the periodic table.
[4] A polymer obtained from the radically polymerizable composition according to any one of [1] to [3].

### Advantageous Effects of Invention

The radically polymerizable composition of the present disclosure is in a liquid state, can easily form a resin having an ionomer structure, and can provide a cured product having excellent properties such as adhesion, tensile properties, and thermoplasticity. The radically polymerizable composition of the present disclosure can thus be suitably used in applications such as various printings, various coatings, adhesion, sealing, and three-dimensional modeling.

### DESCRIPTION OF EMBODIMENTS

Preferred embodiments of the present disclosure are described in detail below; however, the present disclosure is not limited to the following description and can be modified and applied as appropriate without departing from the gist of the present disclosure. In addition, combinations of two or three or more of the preferred embodiments of the present disclosure described below also fall within the scope of the preferred embodiments of the present disclosure. (Meth)acrylic means acrylic or methacrylic. (Meth)allyl means allyl or methallyl.

First, the components constituting the radically polymerizable composition of the present disclosure are described.

### <Water-Immiscible Radically Polymerizable Compound (A)>

In the present invention, in order to obtain an ionically crosslinked resin having an ionomer structure, a water-immiscible radically polymerizable compound (A) is used as a main component for forming a polymer backbone. Here, the “water-immiscible” is determined based on whether or not the compound can be homogenized with water when mixed with an equal mass of water. The “homogeneous” refers to a state in which, when equal amounts of the radically polymerizable compound (A) and water are mixed, no precipitate is visually observed and the liquid mixture is transparent.

The determination of “homogeneous” may be performed at the polymerization temperature and polymerization pressure. More simply, the determination of “homogeneous” may be performed at room temperature and atmospheric pressure. The temperature and pressure during mixing do not have to be room temperature and atmospheric pressure, respectively. Here, the temperature and pressure for the determination are most preferably 20° C. and 101.3 kPa, respectively.

The water-immiscible radically polymerizable compound (A) (hereinafter, sometimes simply referred to as “polymerizable compound (A)”) is a compound that is immiscible with water and has a radically polymerizable group. It can be classified into a monofunctional one that forms a linear polymer through polymerization and a polyfunctional one that forms a covalently crosslinked resin. The radically polymerizable group may be any radically polymerizable unsaturated bond, and is preferably a carbon-carbon double bond, more preferably a carbon-carbon double bond activated with a functional group bonded thereto.

Examples of the carbon-carbon double bond activated include a carbon-carbon double bond with a carbonyl group bonded thereto, a carbon-carbon double bond with a cyano group bonded thereto, a carbon-carbon double bond with a nitrogen atom bonded thereto, a carbon-carbon double bond with an aromatic ring bonded thereto, a carbon-carbon double bond with an oxygen atom bonded thereto, a carbon-carbon double bond conjugated with a carbon-carbon double bond, and a carbon-carbon double bond with a halogen atom bonded thereto. The carbon-carbon double bond in the present invention is not limited to these examples. Of these, a carbon-carbon double bond with a carbonyl group bonded thereto, a carbon-carbon double bond with a cyano group bonded thereto, a carbon-carbon double bond with a nitrogen atom bonded thereto, and a carbon-carbon double bond with an aromatic ring bonded thereto are preferred.

Examples of a compound having a carbon-carbon double bond with a carbonyl group bonded thereto include (meth)acrylic acid esters, 2-(meth)allyloxymethyl acrylic acid esters, (meth)acrylamides, N-substituted maleimides, maleic acid esters, fumaric acid esters, and itaconic acid esters.

Examples of a compound having a carbon-carbon double bond with a cyano group bonded thereto include (meth)acrylonitrile and 2-cyanoacrylic acid esters.

Examples of a compound having a carbon-carbon double bond with a nitrogen atom bonded thereto include N-vinyl amides and vinyl amines.

Examples of a compound having a carbon-carbon double bond with an aromatic ring bonded thereto include aromatic vinyl compounds.

Examples of a compound having a carbon-carbon double bond with an oxygen atom bonded thereto include vinyl esters and vinyl ethers.

Examples of a compound having a carbon-carbon double bond conjugated with a carbon-carbon double bond include 1,3-dienes.

The present disclosure is not limited to these examples.

Of these, from the viewpoints of polymerization activity and wide variety of synthesizable structures, a compound having a carbon-carbon double bond with a carbonyl group bonded thereto is preferred, with (meth)acrylic acid esters and 2-(meth)allyloxymethyl acrylic acid esters being more preferred. From the viewpoints of polymerization activity and effective introduction of a less polar structure, a compound having a carbon-carbon double bond with an aromatic ring bonded thereto is preferred, with aromatic vinyl compounds being more preferred.

The following describes specific examples of compounds belonging to (meth)acrylic acid esters, 2-(meth)allyloxymethyl acrylic acid esters, and aromatic vinyl compounds as the polymerizable compound (A). The compound (A) in the present disclosure is not limited to these examples.

Examples of monofunctional (meth)acrylic acid esters include alkyl esters such as methyl (meth)acrylate, ethyl (meth)acrylate, n-propyl (meth)acrylate, isopropyl (meth)acrylate, n-butyl (meth)acrylate, sec-butyl (meth)acrylate, tert-butyl (meth)acrylate, n-amyl (meth)acrylate, sec-amyl (meth)acrylate, tert-amyl (meth)acrylate, n-hexyl (meth)acrylate, 2-ethylhexyl (meth)acrylate, isodecyl (meth)acrylate, tridecyl (meth)acrylate, lauryl (meth)acrylate, and stearyl (meth)acrylate; alicyclic esters such as cyclohexyl (meth)acrylate, cyclohexylmethyl (meth)acrylate, 3,5,5-trimethylcyclohexyl (meth)acrylate, isobornyl (meth)acrylate, adamantyl (meth)acrylate, and tricyclodecanyl (meth)acrylate; aromatic esters such as benzyl (meth)acrylate and phenyl (meth)acrylate; ether structure-containing esters such as 2-methoxyethyl (meth)acrylate, 2-ethoxyethyl (meth)acrylate, phenoxyethyl (meth)acrylate, tetrahydrofurfuryl (meth)acrylate, glycidyl (meth)acrylate, (3,4-epoxycyclohexyl)methyl (meth)acrylate, and (3-ethyloxetan-3-yl)methyl (meth)acrylate; esters in which one or more or all of the hydrogen atoms of the ester moiety are replaced by fluorine atoms, such as 2, 2,2-trifluoroethyl (meth)acrylate and 2, 2, 3, 3,3-pentafluoropropyl (meth)acrylate; and esters in which one or more or all of the hydrogen atoms of the ester moiety are replaced by silyl groups or silyloxy groups, such as trimethylsilylmethyl (meth)acrylate and 3-[tris (trimethylsilyloxy) silyl]propyl (meth)acrylate. The monofunctional (meth)acrylic acid esters in the present disclosure are not limited to these examples, and may be any ester that has a (meth)acrylic acid ester structure and is immiscible with water.

Examples of polyfunctional (meth)acrylic acid esters include esters of polyhydric alcohols, such as ethylene glycol di(meth)acrylate, propylene glycol di(meth)acrylate, butylene glycol di(meth)acrylate, hexanediol di (meth)acrylate, cyclohexanedimethanol di(meth)acrylate, bisphenol A alkylene oxide di(meth)acrylate, trimethylolpropane tri(meth)acrylate, pentaerythritol tetra(meth)acrylate, dipentaerythritol penta (meth)acrylate, and dipentaerythritol hexa(meth)acrylate; esters of alcohols having a vinyl ether group, such as 2-vinyloxyethyl (meth)acrylate and 2-(vinyloxyethoxy)ethyl (meth)acrylate; and oligomers/polymers having a (meth)acrylic acid ester structure, such as urethane (meth)acrylate oligomers/polymers, epoxy (meth)acrylate oligomers/polymers, and polyester (meth)acrylate oligomers/polymers. The polyfunctional (meth)acrylic acid esters in the present disclosure are not limited to these examples and may be any ester that has a (meth)acrylic acid ester structure and is immiscible with water.

Examples of monofunctional 2-(meth)allyloxymethyl acrylic acid esters include alkyl esters such as methyl 2-(meth)allyloxymethyl acrylate, ethyl 2-(meth)allyloxymethyl acrylate, n-propyl 2-(meth)allyloxymethyl acrylate, isopropyl 2-(meth)allyloxymethyl acrylate, n-butyl 2-(meth)allyloxymethyl acrylate, sec-butyl 2-(meth)allyloxymethyl acrylate, tert-butyl 2-(meth)allyloxymethyl acrylate, n-amyl 2-(meth)allyloxymethyl acrylate, sec-amyl 2-(meth)allyloxymethyl acrylate, tert-amyl 2-(meth)allyloxymethyl acrylate, n-hexyl 2-(meth)allyloxymethyl acrylate, 2-ethylhexyl 2-(meth)allyloxymethyl acrylate, isodecyl 2-(meth)allyloxymethyl acrylate, tridecyl 2-(meth)allyloxymethyl acrylate, lauryl 2-(meth)allyloxymethyl acrylate, and stearyl 2-(meth)allyloxymethyl acrylate; alicyclic esters such as cyclohexyl 2-(meth)allyloxymethyl acrylate, cyclohexylmethyl 2-(meth)allyloxymethyl acrylate, 3, 5,5-trimethylcyclohexyl 2-(meth)allyloxymethyl acrylate, isobornyl 2-(meth)allyloxymethyl acrylate, adamantyl 2-(meth)allyloxymethyl acrylate, and tricyclodecanyl 2-(meth)allyloxymethyl acrylate; aromatic esters such as benzyl 2-(meth)allyloxymethyl acrylate and phenyl 2-(meth)allyloxymethyl acrylate; ether structure-containing esters such as 2-methoxyethyl 2-(meth)allyloxymethyl acrylate, 2-ethoxyethyl 2-(meth)allyloxymethyl acrylate, phenoxyethyl 2-(meth)allyloxymethyl acrylate, tetrahydrofurfuryl 2-(meth)allyloxymethyl acrylate, glycidyl 2-(meth)allyloxymethyl acrylate, (3,4-epoxycyclohexyl)methyl 2-(meth)allyloxymethyl acrylate, and (3-ethyloxetan-3-yl)methyl 2-(meth)allyloxymethyl acrylate; esters in which one or more or all of the hydrogen atoms of the ester moiety are replaced by fluorine atoms, such as 2, 2,2-trifluoroethyl 2-(meth)allyloxymethyl acrylate and 2, 2, 3, 3,3-pentafluoropropyl 2-(meth)allyloxymethyl acrylate; and esters in which one or more or all of the hydrogen atoms of the ester moiety are replaced by silyl groups or silyloxy groups, such as trimethylsilylmethyl 2-(meth)allyloxymethyl acrylate and 3-[tris (trimethylsilyloxy) silyl]propyl 2-(meth)allyloxymethyl acrylate. The monofunctional 2-(meth)allyloxymethyl acrylates in the present disclosure are not limited to these examples and may be any ester that has a 2-(meth)allyloxymethyl acrylic acid ester structure and is immiscible with water.

Examples of polyfunctional 2-(meth)allyloxymethyl acrylic acid esters include esters of polyhydric alcohols such as ethylene glycol di (2-(meth)allyloxymethyl acrylate), propylene glycol di (2-(meth)allyloxymethyl acrylate), butylene glycol di (2-(meth)allyloxymethyl acrylate), hexanediol di (2-(meth)allyloxymethyl acrylate), cyclohexanedimethanol di (2-(meth)allyloxymethyl acrylate), bisphenol A alkylene oxide di (2-(meth)allyloxymethyl acrylate), trimethylolpropane tri (2-(meth)allyloxymethyl acrylate), pentaerythritol tetra (2-(meth)allyloxymethyl acrylate), dipentaerythritol penta (2-(meth)allyloxymethyl acrylate), and dipentaerythritol hexa (2-(meth)allyloxymethyl acrylate); esters of alcohols having a vinyl ether group, such as 2-vinyloxyethyl 2-(meth)allyloxymethyl acrylate and 2-(vinyloxyethoxy)ethyl 2-(meth)allyloxymethyl acrylate; and oligomers/polymers having a 2-(meth)allyloxymethyl acrylic acid ester structure, such as urethane (2-(meth)allyloxymethyl acrylate) oligomers/polymers, epoxy (2-(meth)allyloxymethyl acrylate) oligomers/polymers, and polyester (2-(meth)allyloxymethyl acrylate) oligomers/polymers. The polyfunctional 2-(meth)allyloxymethyl acrylic acid esters in the present disclosure are not limited to these examples and may be any ester that has a (meth)acrylic acid ester structure and is immiscible with water.

Examples of monofunctional or polyfunctional aromatic vinyl compounds include styrene, α-methylstyrene, vinyltoluene, methoxystyrene, and divinylbenzene. The monofunctional or polyfunctional aromatic vinyl compounds in the present disclosure are not limited to these examples and may be any aromatic vinyl compound that has a carbon-carbon double bond with an aromatic ring bonded thereto and is immiscible with water.

The number of carbon atoms in the polymerizable compound (A) is preferably 4 to 90, more preferably 5 to 80, still more preferably 6 to 70 because such a polymerizable compound (A) is immiscible with water and achieves low viscosity even when it is of polyfunctional type.

The polymerizable compound (A) may be one of the above-described polymerizable compounds (A) or include two or more of these depending on the purpose and application.

From the viewpoint of achieving a good balance between the viscosity of the composition and the mechanical properties (e.g., toughness) of the polymer, the amount of the polymerizable compound (A) is preferably 10 to 97% by mass, more preferably 20 to 94% by mass, still more preferably 30 to 90% by mass, in 100% by mass of the radically polymerizable composition.

### <Anion Represented by Formula (1)>

The radically polymerizable composition of the present disclosure contains an anion represented by the following formula (1):

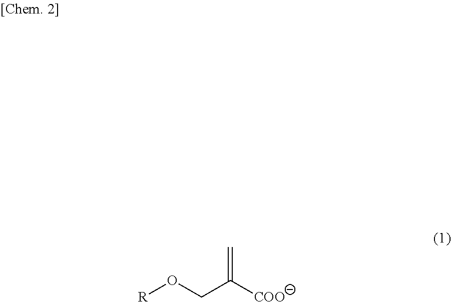

wherein R represents a saturated or unsaturated hydrocarbon group having 10 or less carbon atoms.

Resins such as conventional ionomers synthesized by synthesizing host polymers having ionizable functional groups and then ionizing (neutralizing) the host polymers are poorly soluble in common organic solvents and are difficult to form liquid compositions. Even if the resins could be formed into a liquid state, the resin concentration has to be made quite low. A resin having an ionomer structure is believed to be formed by radically polymerizing a composition including a radically polymerizable salt and a less polar radically polymerizable compound.

Metal salts of (meth)acrylic acid, which have been widely used as radically polymerizable salts, are highly radically polymerizable but are miscible only with water or highly polar organic substances. Such metal salts cannot be homogeneously dissolved in less polar vinyl compounds and cannot be formed into a liquid state easily. Furthermore, polyfunctional acrylic acid esters can be mixed with less polar monomers to form crosslinked resins. However, the crosslinks are covalent, and it is difficult to achieve the properties seen in ionomers, such as thermoplasticity. In the present invention, use of an anion as described above can provide a liquid polymerizable composition that can be homogeneously dissolved in a less polar vinyl compound. Moreover, a resin having an ionomer structure can be successfully formed by a simple method such as a coating or printing process.

The radically polymerizable composition of the present invention containing an anion represented by the formula (1) is preferably prepared using a radically polymerizable carboxylate compound (B) including an anionic component including an anion represented by the formula (1) and a cationic component, as a component for forming an ionically crosslinked structure. In other words, the radically polymerizable composition of the present invention preferably contains a radically polymerizable carboxylate compound (B) formed from an anion including at least an anion represented by the formula (1) and a cation.

From the viewpoint of solubility in the polymerizable compound (A) and in organic solvents, the number of carbon atoms of R is preferably 3 or more, more preferably 3 to 10. From the viewpoint of forming a polar structure by cyclopolymerization, R is more preferably a (meth)allyl group.

When the anion represented by the formula (1) is contained in a ratio of 1 to 120 parts by mass per 100 parts by mass of the polymerizable compound (A) in the radically polymerizable composition of the present invention, a good balance can be achieved between the viscosity of the composition and the mechanical properties (e.g., toughness) of the polymer.

The ratio of the anion represented by the formula (1) per 100 parts by mass the polymerizable compound (A) is preferably 2 to 115 parts by mass, more preferably 3 to 110 parts by mass, still more preferably 10 to 105 parts by mass, even still more preferably 20 to 100 parts by mass.

Hereinafter, the anion represented by the formula (1) may be referred to as a “2-oxymethyl acrylic acid ion” and the radically polymerizable carboxylate compound (B) containing an anion represented by the formula (1) may be referred to as a “polymerizable salt compound (B)”.

The polymerizable salt compound (B) may contain only a 2-oxymethyl acrylic acid ion or may contain a 2-oxymethyl acrylic acid ion and an anion other than a 2-oxymethyl acrylic acid ion, as an anion constituting the polymerizable salt compound (B).

The anion other than a 2-oxymethyl acrylic acid ion is preferably, but not limited to, an organic protonic acid anion from the viewpoint of solubility in the polymerizable compound (A) and organic solvents. Specific examples of the name of the protonic acid of the organic protonic acid anion include carboxylic acids such as formic acid, acetic acid, propionic acid, butyric acid, valeric acid, caproic acid, myristic acid, stearic acid, oxalic acid, malonic acid, succinic acid, adipic acid, cyclohexanetricarboxylic acid, benzoic acid, phthalic acid, terephthalic acid, trimellitic acid, acrylic acid, methacrylic acid, maleic acid, fumaric acid, and itaconic acid; organic phosphoric acids such as 2-ethylhexyl acid phosphate and 2-methacryloyloxyethyl acid phosphate; and organic sulfonic acids such as dodecylbenzenesulfonic acid, p-toluenesulfonic acid, 2-acrylamido-2-methylpropanesulfonic acid, and p-styrenesulfonic acid. The protonic acid in the present disclosure is not limited to these examples.

The cation constituting the polymerizable salt compound (B) may be either an inorganic cation or an organic cation, and may be appropriately selected depending on the purpose and application. The polymerizable salt compound (B) may contain one or two or more cations.

In other words, the radically polymerizable composition of the present invention may further contain a cation, and the cation preferably constitutes the polymerizable salt compound (B).

The inorganic cation may be a metal ion or a metal oxide ion. Specific examples of the name of the element of the metal ion or the name of the metal oxide of the metal oxide ion include Group 1 elements of the periodic table, such as lithium, sodium, and potassium; Group 2 elements of the periodic table, such as magnesium, calcium, and barium; transition metal elements or transition metal oxides, such as lanthanum, zirconium oxide, iron, cobalt, nickel, and copper; and representative metal elements of Groups 12 to 15 of the periodic table, such as zinc, aluminum, tin, lead, and bismuth. The inorganic cation is not limited to these examples and may be a combination of two or more selected from metal ions and metal oxide ions. To allow the polymerizable composition of the present disclosure to be colorless, the metal ion moiety of the carboxylate metal salt is preferably any of ions of representative metal elements, metals of Group 3 and Group 4 of the periodic table, and metal oxides thereof. From the viewpoints of availability and toxicity, lithium, sodium, potassium, magnesium, calcium, zinc, and aluminum are more preferred.

Examples of the organic cation include cations containing non-metallic elements of Group 15 of the periodic table. Non-metallic elements of Group 15 of the periodic table include nitrogen, phosphorus, and arsenic. Preferred examples include ions in which a nitrogen atom is cationized (ammonium ion, protonated amine, and quaternary ammonium ion) and ions in which a phosphorus atom is cationized (phosphonium ion, protonated phosphine, and quaternary ammonium ion). From the viewpoints of biological safety and availability, ions in which a nitrogen atom is cationized are preferred.

Specific examples of the name of the amine of the protonated amine before protonation include monovalent or divalent or more (in terms of amine valency), primary, secondary, or tertiary (in terms of the structure of the nitrogen atom) amines such as methylamine, dimethylamine, trimethylamine, ethylamine, diethylamine, triethylamine, ethanolamine, diethanolamine, triethanolamine, tris(2-aminoethyl)amine, hexamethylenediamine, iminobispropylamine, methyliminobispropylamine, 3, 6, 9,12-tetraoxa-tetradecane-1,14-diamine, N,N″-bis(2-hydroxyethyl)ethylenediamine, 1,3-bisaminomethylcyclohexane, 1,4-bisaminomethylcyclohexane, 3-aminomethyl-3, 5,6-trimethylcyclohexylamine, isophoronediamine, 2,5 (or 2,6)-bis(aminomethyl) bicyclo[2, 2,1]heptane, 2,6 (or 2,7)-bis(aminomethyl) bicyclo[3, 2,1]octane, 2,5 (or 2,6)-bis(aminomethyl)-7-dimethylbicyclo[2, 2,1]heptane, 2,6-bis(aminomethyl) adamantane, m-xylylenediamine, p-phenylenediamine, bis(4-aminophenyl) methane, 1,4 (or 2,6 or 2,7)-bis(aminomethyl) naphthalene, diallylamine, piperazine, aminoethylpiperazine, bisaminopropylpiperazine, 2, 4,6-triamino-1, 3,5-triazine, 2-methylimidazole, 2-ethyl-4-methylimidazole, diazabicycloundecene, diazabicyclononene, 3-aminopropyltrimethoxysilane, 3-aminopropyltriethoxysilane, N-2-(aminoethyl)-3-aminopropylmethyldimethoxysilane, N-2-(aminoethyl)-3-aminopropyltrimethoxysilane, polyethyleneimine, and a diallylamine polymer. The amine in the present disclosure is not limited to these examples.

Specific examples of the quaternary ammonium ion include a tetramethylammonium ion, a tetraethylammonium ion, a tetrabutylammonium ion, a benzyltrimethylammonium ion, and a hexadecyltrimethylammonium ion. The quaternary ammonium ion in the present disclosure is not limited to these examples.

The cation preferably includes one or more cations selected from the group consisting of metal ions, metal oxide ions, and cations containing non-metallic elements of Group 15 of the periodic table.

The polymerizable salt compound (B) is preferably prepared by neutralization between one or two more bases and one or two or more protonic acids each containing at least 2-oxymethyl acrylic acid represented by the following formula (2):

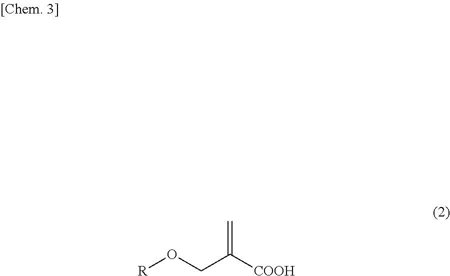

wherein R represents a saturated or unsaturated hydrocarbon group having 10 or less carbon atoms. The protonic acids may be fully or partially neutralized. When the protonic acids are partially neutralized, a mixture of the salt compound and the protonic acid is produced.

R in the formula (2) is the same as R in the formula (1).

Examples of the protonic acids that can be used other than 2-oxymethyl acrylic acid represented by the formula (2) include the above-mentioned organic protonic acids.

Examples of the bases include inorganic bases such as hydroxides and oxides of metal elements of Groups 1 to 15 of the periodic table and organic bases containing non-metallic elements of Group 15 of the periodic table, such as ammonia, amines, and ammonium hydroxide.

The neutralization can be performed by any known method.

The radically polymerizable composition of the present disclosure may contain one or two or more component as the polymerizable salt compound (B).

### <Different Component>

The polymerizable composition of the present disclosure may contain a different component other than the polymerizable compound (A) and the polymerizable salt compound (B) depending on the intended use, application, or the like. Examples of the different component include radical polymerization inhibitors, radical polymerization initiators, solvents, water-miscible radically polymerizable compounds, compounds that undergo a thermal addition reaction or thermal condensation reaction with an active hydrogen group, thermoplastic resins, organic or inorganic fine particles, fillers, dyes, pigments, dispersants, ultraviolet absorbers, leveling agents, surface conditioners, antistatic agents, adhesion improvers, coupling agents, release agents, and viscosity modifiers. The different component in the present disclosure is not limited to these.

Specific examples of major components of the different component are described in detail below, but the different component in the present disclosure is not limited to the following examples.

### Radical Polymerization Inhibitor

From the viewpoint of preventing undesirable radical polymerization during various operations such as storage, transportation, and preparation or treatment of the composition, the radically polymerizable composition of the present disclosure may contain an appropriate amount of a primary antioxidant having radical chain reaction inhibiting properties and/or a secondary antioxidant having peroxide decomposing properties.

Examples of the primary antioxidant include hydroquinones, benzoquinones, phenols, aromatic amines, phenothiazines, metal salts of dithiocarbamic acid, and nitroso compounds. The primary antioxidant in the present disclosure is not limited to these examples. Examples of the secondary antioxidant include phosphorus compounds such as phosphines and phosphites and sulfur compounds such as thioethers, mercaptobenzimidazoles, and thioureas. The secondary antioxidant in the present disclosure is not limited to these examples. One of the primary antioxidant or the secondary antioxidant may be used alone. Preferably, the primary antioxidant and the secondary antioxidant are used in combination.

Of the primary antioxidants, phenols are preferred from the viewpoint of inhibiting discoloration. Of the secondary antioxidants, thioethers are preferred from the viewpoints of acid resistance and hydrolysis resistance.

Examples of the phenols include monoetherified hydroquinones, hindered phenols and oligomers (including dimers) thereof, derivatives of the oligomers, semi-hindered phenols and oligomers (including dimers) thereof, and derivatives of the oligomers. The phenol in the present disclosure is not limited to these examples. These phenols may be used alone or in combination of two or more.

Examples of the monoetherified hydroquinones include hydroquinone monomethyl ether, hydroquinone mono-n-butyl ether, hydroquinone monobenzyl ether, hydroquinone monocyclohexyl ether, and 4-methoxy-1-naphthol. The monoetherified hydroquinones in the present disclosure are not limited to these examples. These monoetherified hydroquinones may be used alone or in combination of two or more.

Examples of the hindered phenols include 2,6-bis(tert-butyl)-4-methylphenol, octadecyl-3-(3,5-di-tert-butyl-4-hydroxyphenyl) propionate, isooctyl-3-(3,5-di-tert-butyl-4-hydroxyphenyl) propionate, 2,4-bis-(n-octylthio)-6-(4-hydroxy-3,5-di-tert-butylanilino)-1, 3,5-triazine, and 3,5-di-tert-butyl-4-hydroxybenzylphosphonate-diethyl ester. The hindered phenols in the present disclosure are not limited to these examples.

Examples of the oligomers of the hindered phenols and the derivatives of the oligomers include pentaerythrityl tetrakis[3-(3,5-di-tert-butyl-4-hydroxyphenyl) propionate], 2,2-thio-diethylenebis[3-(3,5-di-tert-butyl-4-hydroxyphenyl) propionate], N,N′-hexamethylenebis(3,5-di-tert-butyl-4-hydroxy-hydrocinnamamide), 1,6-hexanediol-bis[3-(3,5-di-tert-butyl-4-hydroxyphenyl) propionate], tris-(3,5-di-tert-butyl-4-hydroxybenzyl) isocyanurate, and 1,3,5-trimethyl-2, 4,6-tris(3,5-di-tert-butyl-4-hydroxybenzyl)benzene. The oligomers and the derivatives in the present disclosure are not limited to these examples. The hindered phenols, the oligomers (including dimers) thereof, and the derivatives of the oligomers may be used alone or in combination of two or more.

Examples of the semi-hindered phenols include 6-tert-butyl-o-cresol, 6-tert-butyl-2,4-xylenol, 2, 4, 8,10-tetra-tert-butyl-6-[3-(3-methyl-4-hydroxy-5-t-butylphenyl) propoxy]dibenzo[d, f][1, 3,2]dioxaphosphepine, 2,4-dimethyl-6-(1-methylpentadecyl) phenol, 2,4-bis(octylthiomethyl)-o-cresol, 2,4-bis(dodecylthiomethyl)-o-cresol, 2-tert-butylphenol, 2,4-di-tert-butylphenol, 2-tert-amylphenol, and 2,4-di-tert-amylphenol. The semi-hindered phenols in the present disclosure are not limited to these examples.

Examples of the oligomers of the semi-hindered phenols and the derivatives of the oligomers include methylene bis(oxyethylene)bis[3-(5-tert-butyl-4-hydroxy-m-tolyl) propionate], triethylene glycol bis[β-(3-tert-butyl-5-methyl-4-hydroxyphenyl) propionate], 4,4′-thiobis(2-methyl-6-tert-butylphenol), bis(3-methyl-4-hydroxy-5-tert-butylbenzyl) sulfide, terephthaloyl-di (2,6-dimethyl-4-tert-butyl-3-hydroxybenzyl sulfide), 3,9-bis[2-[3-(3-tert-butyl-4-hydroxy-5-methylphenyl) propionic acid]-1,1-dimethylethyl]-2, 4, 8,10-tetraoxaspiro[5.5]undecane, 4,4′-butylidenebis(6-tert-butyl-3-methylphenol), 4,4′-thiobis(6-tert-butyl-3-methylphenol), 1, 1,3-tris(2-methyl-4-hydroxy-5-tert-butylphenyl) butane, 2,2′-methylenebis(4-methyl-6-tert-butylphenol), 2,2′-methylenebis(4-ethyl-6-tert-butylphenol), 2,2′-thiobis(4-methyl-6-tert-butylphenol), and 2-[1-(2-hydroxy-3,5-di-tert-pentylphenyl)ethyl]-4,6-di-tert-pentylphenyl acrylate, and 2-tert-butyl-6-(3-tert-butyl-2-hydroxy-5-methylbenzyl)-4-methylphenylacrylate. The oligomers and the derivatives in the present disclosure are not limited to these examples. The semi-hindered phenols, the oligomers (including dimers) thereof, and the derivatives of the oligomers may be used alone or in combination of two or more.

Examples of the phosphines include triethylphosphine, tributylphosphine, tris(2-ethylhexyl) phosphine, and triphenylphosphine. The phosphines in the present disclosure are not limited to these examples. These phosphines may be used alone or in combination of two or more.

Examples of the phosphites include diethyl hydrogen phosphite, bis(2-ethylhexyl) hydrogen phosphite, dilauryl hydrogen phosphite, dioleyl hydrogen phosphite, diphenyl hydrogen phosphite, triethyl phosphite, tributyl phosphite, tris (2-ethylhexyl) phosphite, triisodecyl phosphite, trilauryl phosphite, tris (tridecyl phosphite), trioleyl phosphite, tristearyl phosphite, phenyl diisodecyl phosphite, diphenyl methyl phosphite, 2-ethylhexyl diphenyl phosphite, isodecyl diphenyl phosphite, tridecyl diphenyl phosphite, bis(2,4-di-tert-butyl-6-methylphenyl) ethyl phosphite, triphenyl phosphite, tricresyl phosphite, tris (nonylphenyl) phosphite, tris(2,4-di-tert-butylphenyl) phosphite, bis(isodecyl) pentaerythritol diphosphite, bis(tridecyl) pentaerythritol diphosphite, bis(stearyl) pentaerythritol diphosphite, bis(nonylphenyl) pentaerythritol diphosphite, bis(2,4-di-tert-butylphenyl) pentaerythritol diphosphite, bis(2,6-di-tert-butyl-6-methylphenyl) pentaerythritol diphosphite, 4,4′-butylidenebis(3-methyl-6-tert-butylphenyldiisotridecyl) phosphite, tetraphenyldipropylene glycol diphosphite, tetraphenyltetra (tridecyl) pentaerythritol tetraphosphite, tetra (C12-C15 alkyl)-4,4′-isopropylidenediphenyl phosphite, tetra (tridecyl)-1, 1,3-tris(2-methyl-5-tert-butyl-4-hydroxyphenyl) butane diphosphite, 2, 4, 8,10-tetra-tert-butyl-6-[3-(3-methyl-4-hydroxy-5-tert-butylphenyl) propoxy]dibenzo[d, f][1, 3,2]dioxaphosphepine, 2,2-methylenebis(4,6-tert-butylphenyl)-2-ethylhexyl phosphite, and trilauryl trithiophosphite. The phosphites in the present disclosure are not limited to these examples. These phosphites may be used alone or in combination of two or more.

Examples of the thioethers include 2, 2 ‘-thiodiglycolic acid, (ethylenedithio) diacetic acid, 2, 2’-(ethylenedithio) diethanol, 3,3′-thiodipropionic acid, dimethyl 3,3′-thiodipropionate, 3-laurylthiopropionic acid, methyl 3-laurylthiopropionate, (3-octylthiopropionic acid) pentaerythritol tetraester, (3-decylthiopropionic acid) pentaerythritol tetraester, (3-laurylthiopropionic acid) pentaerythritol tetraester, (3-oleylthiopropionic acid) pentaerythritol tetraester, (3-stearylthiopropionic acid) pentaerythritol tetraester, (3-laurylthiopropionic acid)-4,4′-thiodi (3-methyl-5-tert-butyl-4-phenol) ester, dioctylthiodipropionate, didecylthiodipropionate, dilaurylthiodipropionate, dimyristylthiodipropionate, distearylthiodipropionate, laurylstearylthiodipropionate, distearyl-β,β′-thiodibutyrate, dimethyl sulfide, methyldodecyl sulfide, dilauryl sulfide, distearyl sulfide, 2,4-bis(octylthiomethyl)-o-cresol, and 2,4-bis(dodecylthiomethyl)-o-cresol. The thioethers in the present disclosure are not limited to these examples. These thioethers may be used alone or in combination of two or more.

From the viewpoint of preventing radical polymerization during various operations such as storage, transportation, and preparation or treatment of the composition while ensuring radical polymerizability appropriate for the application, the amount of the radical polymerization inhibitor is preferably 0.005 to 2 parts by mass, more preferably 0.01 to 1 part by mass, still more preferably 0.02 to 0.5 parts by mass, per 100 parts by mass of the total of the radically polymerizable components.

### Radical Polymerization Initiator

Radical polymerization initiators are classified into photoradical initiators that generate radicals upon irradiation with active energy rays and thermal radical initiators that generate radicals upon heating. They can be selected according to the application or purpose. A photoradical initiator and a thermal radical initiator may be used in combination.

Examples of photoradical initiators include alkylphenone compounds, benzophenone compounds, benzoin compounds, ketal compounds, anthraquinone compounds, phosphine oxide compounds, thioxanthone compounds, halomethylated triazine compounds, halomethylated oxadiazole compounds, biimidazole compounds, oxime ester compounds, titanocene compounds, benzoic acid ester compounds, and acridine compounds. The photoradical initiators in the present disclosure are not limited to these examples. These photoradical initiators may be used alone or in combination of two or more.

Specific examples of the photoradical initiators include alkylphenone compounds such as acetophenone, 1,1-dichloroacetophenone, 2,2-diethoxyacetophenone, 2,2-dimethoxy-2-phenylacetophenone, 2,2-diethoxy-2-phenylacetophenone, 1-hydroxycyclohexyl phenyl ketone, 2-hydroxy-2-methyl-1-phenylpropan-1-one, 1-[4-(2-hydroxyethoxy)phenyl]-2-hydroxy-2-methyl-1-propan-1-one, 2-hydroxy-1-{4-[4-(2-hydroxy-2-methylpropionyl)benzyl]phenyl}-2-methylpropan-1-one, 2-methyl-1-(4-methylthiophenyl)-2-morpholinopropan-1-one, 2-benzyl-2-dimethylamino-1-(4-morpholinophenyl)-1-butanone, and 2-(dimethylamino)-2-[(4-methylphenyl)methyl]-1-[4-(4-morpholinyl)phenyl]-1-butanone; benzophenone and benzophenone compounds such as 4,4′-bis(dimethylamino)benzophenone, 2-carboxybenzophenone, and 4-benzoyl-4′-methyldiphenyl sulfide; benzoin compounds such as benzoin methyl ether, benzoin ethyl ether, benzoin isopropyl ether, and benzoin isobutyl ether; ketal compounds such as acetophenone dimethyl ketal and benzyl dimethyl ketal; anthraquinone compounds such as 2-ethylanthraquinone, 2-t-butylanthraquinone, 2-chloroanthraquinone, and 2-amylanthraquinone; phosphine oxide compounds such as 2, 4,6-trimethylbenzoyldiphenyl phosphine oxide, bis-(2,6-dimethoxybenzoyl)-2, 4,4-trimethylpentylphosphine oxide, and bis(2, 4,6-trimethylbenzoyl)-phenylphosphine oxide; thioxanthone and thioxanthone compounds such as 2-ethylthioxanthone, 2-isopropylthioxanthone, 2-chlorothioxanthone, 2,4-dimethylthioxanthone, 2,4-diethylthioxanthone, and [3-(3,4-dimethyl-9-oxothioxanthen-2-yl)oxy-2-hydroxypropyl]-trimethylazanium chloride; halomethylated triazine compounds such as 2-(4-methoxyphenyl)-4,6-bis(trichloromethyl)-sec-triazine, 2-(4-methoxynaphthyl)-4,6-bis(trichloromethyl)-sec-triazine, 2-(4-ethoxynaphthyl)-4,6-bis(trichloromethyl)-sec-triazine, and 2-(4-ethoxycarboxynylnaphthyl)-4,6-bis(trichloromethyl)-sec-triazine; halomethylated oxadiazole compounds such as 2-trichloromethyl-5-[β-(2′-benzofuryl) vinyl]-1, 3,4-oxadiazole, 2-trichloromethyl-5-[β-(2 ‘-(6″-benzofuryl) vinyl)]-1, 3,4-oxadiazole, and 2-trichloromethyl-5-furyl-1, 3,4-oxadiazole; biimidazole compounds such as 2, 2’-bis(2-chlorophenyl)-4, 4 ‘, 5, 5’-tetraphenyl-1, 2 ‘-biimidazole, 2,2’-bis(2,4-dichlorophenyl)-4, 4 ‘, 5, 5’-tetraphenyl-1,2′-biimidazole, and 2, 2 ‘-bis (2, 4,6-trichlorophenyl)-4, 4’, 5, 5 ‘-tetraphenyl-1, 2’-biimidazole; oxime ester compounds such as 1-[4-(phenylthio)-, 2-(0-benzoyloxime)]-1,2-octanedione, 1-[9-ethyl-6-(2-methylbenzoyl)-9H-carbazol-3-yl]-, 1-(0-acetyloxime) ethanone; titanocene compounds such as bis(n5-2,4-cyclopentadien-1-yl)-bis (2,6-difluoro-3-(1H-pyrrol-1-yl)-phenyl) titanium; acylphosphine oxide compounds such as bis (2, 4,6-trimethylbenzoyl)-phenylphosphine oxide and 2, 4,6-trimethylbenzoyl-diphenylphosphine oxide; benzoic acid ester compounds such as p-dimethylaminobenzoic acid and p-diethylaminobenzoic acid; and acridine compounds such as 9-phenylacridine. The photoradical initiators in the present disclosure are not limited to these examples.

The thermal radical initiators are preferably organic peroxide initiators or azo initiators. The following describes specific examples thereof.

Examples of organic peroxide initiators include methyl ethyl ketone peroxide, cyclohexanone peroxide, methylcyclohexanone peroxide, methylacetoacetate peroxide, acetylacetate peroxide, 1,1-bis(t-hexylperoxy)-3, 3,5-trimethylcyclohexane, 1,1-bis(t-hexylperoxy)cyclohexane, 1,1-bis(t-butylperoxy)-3, 3,5-trimethylcyclohexane, 1,1-bis(t-butylperoxy)-2-methylcyclohexane, 1,1-bis(t-butylperoxy)cyclohexane, 1,1-bis(t-butylperoxy) cyclododecane, 1,1-bis(t-butylperoxy) butane, 2,2-bis(4,4-di-t-butylperoxycyclohexyl) propane, p-menthane hydroperoxide, diisopropylbenzene hydroperoxide, 1, 1, 3,3-tetramethylbutyl hydroperoxide, cumene hydroperoxide, t-hexyl hydroperoxide, t-butyl hydroperoxide, a, a′-bis(t-butylperoxy)diisopropylbenzene, dicumyl peroxide, 2,5-dimethyl-2,5-bis(t-butylperoxy) hexane, t-butylcumyl peroxide, di-t-butyl peroxide, 2,5-dimethyl-2,5-bis(t-butylperoxy) hexyne-3, isobutyryl peroxide, 3, 5,5-trimethylhexanoyl peroxide, octanoyl peroxide, lauroyl peroxide, stearoyl peroxide, succinic acid peroxide, m-toluoyl benzoyl peroxide, benzoyl peroxide, di-n-propyl peroxydicarbonate, diisopropyl peroxydicarbonate, bis(4-t-butylcyclohexyl) peroxydicarbonate, di-2-ethoxyethyl peroxydicarbonate, di-2-ethoxyhexyl peroxydicarbonate, di-3-methoxybutyl peroxydicarbonate, di-s-butyl peroxydicarbonate, di (3-methyl-3-methoxybutyl) peroxydicarbonate, α,α′-bis(neodecanoylperoxy)diisopropylbenzene, cumyl peroxyneodecanoate, 1, 1, 3,3-tetramethylbutyl peroxyneodecanoate, 1-cyclohexyl-1-methylethyl peroxyneodecanoate, t-hexylperoxyneodecanoate, t-butyl peroxyneodecanoate, t-hexylperoxypivalate, t-butylperoxypivalate, 1, 1, 3,3-tetramethylbutylperoxy-2-ethylhexanoate, 2,5-dimethyl-2,5-bis(2-ethylhexanoylperoxy) hexanoate, 1-cyclohexyl-1-methylethylperoxy-2-ethylhexanoate, t-hexylperoxy-2-ethylhexanoate, t-butylperoxy-2-ethylhexanoate, t-hexylperoxyisopropyl monocarbonate, t-butylperoxyisobutyrate, t-butylperoxymalate, t-butylperoxy-3, 5,5-trimethylhexanoate, t-butylperoxylaurate, t-butylperoxyisopropyl monocarbonate, t-butylperoxy-2-ethylhexyl monocarbonate, t-butylperoxyacetate, t-butylperoxy-m-toluylbenzoate, t-butylperoxybenzoate, bis(t-butylperoxy) isophthalate, 2,5-dimethyl-2,5-bis(m-tolylperoxy) hexane, t-hexylperoxybenzoate, 2,5-dimethyl-2,5-bis(benzoylperoxy) hexane, t-butylperoxyallyl monocarbonate, t-butyltrimethylsilyl peroxide, 3, 3′,4,4′-tetra (t-butylperoxycarbonyl)benzophenone, and 2,3-dimethyl-2,3-diphenylbutane.

Examples of azo initiators include 2-phenylazo-4-methoxy-2,4-dimethylvaleronitrile, 1-[(1-cyano-1-methylethyl) azo]formamide, 1,1′-azobis(cyclohexane-1-carbonitrile), 2,2′-azobis(2-methylbutyronitrile), 2, 2 ‘-azobisisobutyronitrile, 2, 2’-azobis(2,4-dimethylvaleronitrile), 2,2′-azobis(2,4-dimethyl-4-methoxyvaleronitrile), 2, 2 ‘-azobis(2-methylpropionamidine) dihydrochloride, 2, 2’-azobis(2-methyl-N-phenylpropionamidine) dihydrochloride, 2, 2 ‘-azobis[N-(4-chlorophenyl)-2-methylpropionamidine]dihydrochloride, 2, 2’-azobis[N-(4-hydrophenyl)-2-methylpropionamidine]dihydrochloride, 2, 2 ‘-azobis[2-methyl-N-(phenylmethyl) propionamidine]dihydrochloride, 2, 2’-azobis[2-methyl-N-(2-propenyl) propionamidine]dihydrochloride, 2, 2 ‘-azobis[N-(2-hydroxyethyl)-2-methylpropionamidine]dihydrochloride, 2, 2’-azobis[2-(5-methyl-2-imidazolin-2-yl) propane]dihydrochloride, 2, 2 ‘-azobis[2-(2-imidazolin-2-yl) propane]dihydrochloride, 2, 2’-azobis[2-(4, 5, 6, 7-tetrahydro-1H-1,3-diazepin-2-yl) propane]dihydrochloride, 2, 2 ‘-azobis[2-(3, 4, 5, 6-tetrahydropyrimidin-2-yl) propane]dihydrochloride, 2, 2’-azobis[2-(5-hydroxy-3, 4, 5, 6-tetrahydropyrimidin-2-yl) propane]dihydrochloride, 2, 2 ‘-azobis {2-[1-(2-hydroxyethyl)-2-imidazolin-2-yl]propane}dihydrochloride, 2, 2’-azobis[2-(2-imidazolin-2-yl) propane], 2, 2 ‘-azobis {2-methyl-N-[1,1-bis(hydroxymethyl)-2-hydroxyethyl]propionamide}, 2, 2’-azobis {2-methyl-N-[1,1-bis(hydroxymethyl)ethyl]propionamide}, 2, 2 ‘-azobis[2-methyl-N-(2-hydroxyethyl) propionamide], 2, 2’-azobis(2-methylpropionamide), 2,2′-azobis(2, 4, 4-trimethylpentane), 2, 2 ‘-azobis(2-methylpropane), dimethyl-2, 2-azobis(2-methylpropionate), 4, 4’-azobis(4-cyanopentanoic acid), and 2, 2′-azobis[2-(hydroxymethyl) propionitrile].

These may be used alone or in combination of two or more.

The amount of the radical polymerization initiator is preferably, but not limited to, 0.05 to 10.0 parts by mass, more preferably 0.1 to 7.0 parts by mass, still more preferably 0.2 to 5.0 parts by mass, per 100 parts by mass of the total of the radically polymerizable components.

### Solvent

From the viewpoints of adjustment of the viscosity, adjustment of the thickness of the coating film, dissolution of the resin, combining of the hydrophilic components, and the like, an appropriate amount of an organic solvent or water may be contained.

Examples of the organic solvent include monoalcohols such as methanol, ethanol, isopropanol, n-butanol, and sec-butanol; glycols such as ethylene glycol and propylene glycol; cyclic ethers such as tetrahydrofuran and dioxane; glycol monoethers such as ethylene glycol monomethyl ether, ethylene glycol monoethyl ether, ethylene glycol monobutyl ether, diethylene glycol monomethyl ether, diethylene glycol monoethyl ether, diethylene glycol monobutyl ether, propylene glycol monomethyl ether, propylene glycol monoethyl ether, propylene glycol monobutyl ether, and 3-methoxybutanol; glycol ethers such as ethylene glycol dimethyl ether, ethylene glycol diethyl ether, ethylene glycol ethyl methyl ether, diethylene glycol dimethyl ether, diethylene glycol diethyl ether, diethylene glycol ethyl methyl ether, propylene glycol dimethyl ether, and propylene glycol diethyl ether; esters of glycol monoethers such as ethylene glycol monomethyl ether acetate, ethylene glycol monoethyl ether acetate, ethylene glycol monobutyl ether acetate, diethylene glycol monomethyl ether acetate, diethylene glycol monoethyl ether acetate, diethylene glycol monobutyl ether acetate, propylene glycol monomethyl ether acetate, propylene glycol monoethyl ether acetate, propylene glycol monobutyl ether acetate, dipropylene glycol monomethyl ether acetate, dipropylene glycol monoethyl ether acetate, dipropylene glycol monobutyl ether acetate, and 3-methoxybutyl acetate; alkyl esters such as methyl acetate, ethyl acetate, propyl acetate, isopropyl acetate, butyl acetate, methyl propionate, ethyl propionate, butyl propionate, methyl lactate, ethyl lactate, butyl lactate, methyl 3-methoxypropionate, ethyl 3-methoxypropionate, methyl 3-ethoxypropionate, ethyl 3-ethoxypropionate, methyl acetoacetate, and ethyl acetoacetate; ketones such as acetone, methyl ethyl ketone, methyl isobutyl ketone, and cyclohexanone; aromatic hydrocarbon compounds such as benzene, toluene, xylene, and ethylbenzene; aliphatic hydrocarbon compounds such as hexane, cyclohexane, and octane; and amides such as dimethylformamide, dimethylacetamide, and N-methylpyrrolidone. The organic solvent in the present disclosure is not limited to these examples. These organic solvents may be used alone or in combination of two or more.

### Water-Miscible Radically Polymerizable Compound

The radically polymerizable composition of the present invention may contain an appropriate amount of a water-miscible radically polymerizable compound depending on the purpose ands application. Specific examples of the water-miscible radically polymerizable compound include (meth)acrylic acid, salts of (meth)acrylic acid, 2-acrylamido-2-methylpropanesulfonic acid, salts of 2-acrylamido-2-methylpropanesulfonic acid, 2-hydroxyethyl (meth)acrylate, glycerol mono(meth)acrylate, (meth)acrylamide, acryloylmorpholine, N-vinylacetamide, N-vinylpyrrolidone, and polyethylene glycol di(meth)acrylate. The water-miscible radically polymerizable compound may be any compound that is miscible with water and has a radically polymerizable group.

Compound that Undergoes Thermal Addition Reaction or Thermal Condensation Reaction with Active Hydrogen Group

The radically polymerizable composition of the present invention may contain an appropriate amount of one or two or more compounds that undergo a thermal addition reaction or thermal condensation reaction with an active hydrogen group, from the viewpoint of improving the heat resistance and hardness of the cured product.

Such compounds may each have a functional group that undergoes a thermal addition reaction or thermal condensation reaction with an active hydrogen group. The compounds may each contain functional groups of the same type or of different types in one molecule. Also, the compounds may each contain one functional group or two or more functional groups in one molecule.

Examples of the functional group that undergoes a thermal addition reaction or thermal condensation reaction with an active hydrogen group include an epoxy group, an oxetanyl group, a carbodiimide group, an oxazoline group, an aziridine group, an isocyanate group, an alkoxysilyl group, and a hydroxymethyl group or alkoxymethyl group bonded to a nitrogen atom. The functional group in the present disclosure is not limited to these examples.

Examples of a compound having an epoxy group include compounds having a glycidyl group such as glycidyl (meth)acrylate, 2-ethylhexyl glycidyl ether, p-tert-butylphenyl glycidyl ether, N-glycidyl phthalimide, ethylene glycol diglycidyl ether, diethylene glycol diglycidyl ether, 1,4-butanediol diglycidyl ether, 1,6-hexanediol diglycidyl ether, resorcinol diglycidyl ether, neopentyl glycol diglycidyl ether, polyethylene glycol diglycidyl ether, polypropylene glycol diglycidyl ether, bisphenol A diglycidyl ether, hydrogenated bisphenol A diglycidyl ether, bisphenol F diglycidyl ether, glycerol polyglycidyl ether, trimethylolpropane polyglycidyl ether, sorbitol polyglycidyl ether, diglycerol polyglycidyl ether, polyglycerol polyglycidyl ether, phenol novolac polyglycidyl ether, o-cresol novolac polyglycidyl ether, triglycidyl isocyanurate, and 4, 4′-methylenebis (N, N-diglycidylaniline); compounds having an alicyclic epoxy group such as (3, 4-epoxycyclohexyl)methyl (meth)acrylate, (3, 4-epoxycyclohexylmethyl) 3, 4-epoxycyclohexanecarboxylate, 1, 2-epoxy-4-vinyl-1-cyclohexene, bis(3, 4-epoxycyclohexylmethyl) adipate, and 4-vinylcyclohexene dioxide; and radical (co) polymers of compounds having a radically polymerizable group and an epoxy group, such as glycidyl (meth)acrylate and (3,4-epoxycyclohexyl)methyl (meth)acrylate. The compound in the present disclosure is not limited to these examples.

Examples of a compound having an oxetanyl group include low molecular compounds such as (3-ethyl-3-oxetanyl)methyl (meth)acrylate, 3-allyloxymethyl-3-ethyloxetane, 2-ethylhexylmethyl-3-ethyloxetane, bis(3-ethyl-3-oxetanylmethyl) ether, bis[(3-ethyl-3-oxetanyl)methyl]isophthalate, and 4, 4′-bis[(3-ethyl-3-oxetanyl) methoxymethyl]biphenyl; and radical (co) polymers of compounds having a radically polymerizable group and an oxetanyl group, such as (3-ethyl-3-oxetanyl)methyl (meth)acrylate. The compound in the present disclosure is not limited to these examples.

Examples of a compound having a carbodiimide group include N,N′-diisopropylcarbodiimide, N,N′-di-tert-butylcarbodiimide, N,N′-dicyclohexylcarbodiimide, bis(2, 6-diisopropylphenyl) carbodiimide, 1-ethyl-3-(3-dimethylaminopropyl) carbodiimide, 1-ethyl-3-(3-dimethylaminopropyl) carbodiimide hydrochloride, and Carbodista (product name, Teijin Limited). The compound in the present disclosure is not limited to these examples.

Examples of a compound having an oxazoline group include EPOCROS WS-300 (product name, Nippon Shokubai Co., Ltd.), EPOCROS WS-500 (product name, Nippon Shokubai Co., Ltd.), EPOCROS WS-700 (product name, Nippon Shokubai Co., Ltd.), and EPOCROS RPS-1005 (product name, Nippon Shokubai Co., Ltd.). The compound in the present disclosure is not limited to these examples.

Examples of a compound having an aziridine group include Chemitite PZ-33 (product name, Nippon Shokubai Co., Ltd.) and Chemitite DZ-22E (product name, Nippon Shokubai Co., Ltd.). The compound in the present disclosure is not limited to these examples.

Examples of a compound having an isocyanate group include low molecular compounds such as 2-isocyanatoethyl (meth)acrylate, tolylene diisocyanate, xylylene diisocyanate, bis(isocyanatomethyl)cyclohexane, hexamethylene diisocyanate, isophorone diisocyanate, and diphenylmethane diisocyanate (monomeric MDI); and high molecular compounds such as radical (co)polymers of compounds having a radically polymerizable group and an isocyanate group, such as polymeric MDI and 2-isocyanatoethyl (meth)acrylate, and isocyanate group-terminated prepolymers obtained by reacting a polyol with excess polyisocyanate. The compound in the present disclosure is not limited to these examples. The isocyanate group may be masked with a blocking agent such as phenol, ε-caprolactam, methyl ethyl ketone oxime, diethyl malonate, ethyl acetoacetate, or dimethylpyrazole.

Examples of a compound having an alkoxysilyl group include low molecular compounds such as tetramethoxysilane, tetraethoxysilane, hydrolysis/polycondensation oligomers of tetramethoxysilane, hydrolysis/polycondensation oligomers of tetraethoxysilane, 3-(trimethoxysilyl) propyl (meth)acrylate, 3-[dimethoxy(methyl) silyl]propyl (meth)acrylate, 3-(triethoxysilyl) propyl (meth)acrylate, 3-[diethoxy (methyl) silyl]propyl (meth)acrylate, 3-glycidoxypropylmethyldimethoxysilane, 3-glycidoxypropyltrimethoxysilane, 3-glycidoxypropylmethyldiethoxysilane, 3-glycidoxypropyltriethoxysilane, 2-(3,4-epoxycyclohexyl)ethyltrimethoxysilane, 3-aminopropyltrimethoxysilane, 3-aminopropyltriethoxysilane, N-2-(aminoethyl)-3-aminopropylmethyldimethoxysilane, N-2-(aminoethyl)-3-aminopropyltrimethoxysilane, 3-mercaptopropyltrimethoxysilane, 3-isocyanatopropyltriethoxysilane, 3-trimethoxysilylpropylsuccinic anhydride, vinyltrimethoxysilane, vinyltriethoxysilane, tris[3-(trimethoxysilyl) propyl]isocyanurate, bis[3-(trimethoxysilyl) propyl]amine, and 1, 6-bis(trimethoxysilyl) hexane; and high molecular compounds such as alkoxysilyl-terminated polydimethylsiloxane and radical (co) polymers of compounds having a radically polymerizable group and an alkoxysilyl group, such as 3-(trimethoxysilyl) propyl (meth)acrylate and 3-(triethoxysilyl) propyl (meth)acrylate. The compound in the present disclosure is not limited to these examples.

Examples of a compound having a hydroxymethyl group or an alkoxymethyl group bonded to a nitrogen atom include hydroxymethylated (meth)acrylamide compounds such as N-(hydroxymethyl) (meth)acrylamide, N-(methoxymethyl) (meth)acrylamide, radical (co) polymers of N-(hydroxymethyl) (meth)acrylamide or N-(methoxymethyl) (meth)acrylamide; melamine resins such as hexamethylol melamine, partially or completely methyl-etherified hexamethylol melamine, partially methylolated melamine, and methyl-etherified partially methylolated melamine; benzoguanamine resins such as tetramethylol benzoguanamine and methyl-etherified tetramethylol benzoguanamine; and urea resins such as 1, 3, 4, 6-tetrakis(methoxymethyl) glycoluril, dimethylol dihydroxyethylene urea, and methyl-etherified dimethylol dihydroxyethylene urea. The compound in the present disclosure is not limited to these examples.

The radically polymerizable composition may contain any of the compounds that undergo a thermal addition reaction or thermal condensation reaction with an active hydrogen group in an amount adjusted depending on the application or purpose, but may not contain the compound. The amount of the compound(s), when contained, is preferably 1 part by mass or more and 90 parts by mass or less, more preferably 2 parts by mass or more and 85 parts by mass or less, still more preferably 3 parts by mass or more and 80 parts by mass or less, per 100 parts by mass of the polymerizable composition of the present disclosure.

### <Polymer of the Present Disclosure>

The polymer of the present disclosure can be obtained by reacting the radically polymerizable composition of the present disclosure. The reacting includes at least radical polymerization mediated by radicals generated in the radically polymerizable composition of the present disclosure. The present disclosure also encompasses a radical polymer obtained from the radically polymerizable composition of the present disclosure, which is such a polymer obtained by polymerizing the radically polymerizable composition of the present disclosure under radical generating conditions.

A method of generating radicals may be a method of heating the radically polymerizable composition of the present disclosure and/or a method of irradiation with active energy rays to the radically polymerizable composition of the present disclosure. The heating and the irradiation with active energy rays may each be performed in one step or in two or more steps. The method of generating radicals may include a combination of heating and irradiation with active energy rays, and the heating and the irradiation with active energy rays may be performed at the same time or separately. When the heating or the irradiation with active energy rays is performed, the radically polymerizable composition of the present disclosure more preferably contains any of the above-mentioned radical polymerization initiators.

The temperature of the heating when performed may be appropriately selected depending on the presence or absence, type, amount, or application of the polymerizable composition. When a thermal radical initiator is used, the temperature is 40° C. or higher, more preferably 50° C. or higher, still more preferably 60° C. or higher.

The active energy rays may be those commonly used, including electromagnetic waves such as gamma rays, X-rays, ultraviolet light, visible light, and infrared rays, and particle beams such as electron beams, neutron beams, and proton beams. Of these, from the viewpoints of energy intensity, energy ray generator, and the like, gamma rays, X-rays, ultraviolet light, visible light, and electron beams are preferred, ultraviolet light, visible light, and electron beams are more preferred, and ultraviolet light is most preferred. When a photoradical initiator is not used, active energy rays which have high energy are preferably used such as gamma rays, X-rays, and electron beams, whereas when a photoradical initiator is used, active energy rays which have relatively low energy but are easy to generate and economical are preferably used such as ultraviolet light and visible light.

The reaction for obtaining the polymer of the present disclosure includes at least radical polymerization mediated by radicals generated in the radically polymerizable composition of the present disclosure. The reaction may include a different reaction other than the radical polymerization. Preferred examples of the different reaction include a thermal addition reaction with an active hydrogen group and a thermal condensation reaction with an active hydrogen group. These reactions may be performed before, simultaneously with, or after the radical polymerization. When a thermal addition reaction with an active hydrogen group or a thermal condensation reaction with an active hydrogen group is performed, the polymerizable composition of the present disclosure more preferably contains any of the above-described compounds that undergo a thermal addition reaction or thermal condensation reaction with an active hydrogen group.

The heating temperature may be appropriately selected depending on the type, amount, and application of any of the above-described compounds that undergo a thermal addition reaction or thermal condensation reaction with an active hydrogen group, and is preferably 40° C. or higher, more preferably 70° C. or higher, still more preferably 90° C. or higher.

The polymer of the present disclosure contains a structural unit (a) derived from the polymerizable compound (A) and a structural unit (b) derived from the 2-oxymethyl acrylic acid ion, and may further contain a structural unit (c) derived from another polymerizable compound.

The polymer may have the structural units (a) of the same type or of different types, the structural units (b) of the same type or of different types, or the structural units (c) of the same type or of different types.

A preferred proportion of the structural unit (a) in the polymer is the same as the proportion of the polymerizable compound (A) in the polymerizable composition of the present disclosure. A preferred proportion of the structural unit (b) is the same as the proportion of the 2-oxymethyl acrylic acid ion in the polymerizable composition of the present disclosure.

Here, the “structural unit (a) derived from the polymerizable compound (A)” and the “structural unit (b) derived from the 2-oxymethyl acrylic acid ion” have the same structures of the structural units contained in a polymer obtained by radical polymerization of the “polymerizable compound (A)” and the “2-oxymethyl acrylic acid ion”, respectively.

The structural unit (a) and the structural unit (b) do not necessarily have to be structural units formed by radical polymerization of the polymerizable compound (A) and the 2-oxymethyl acrylic acid ion, respectively. The structural unit (a) and the structural unit (b) may be structural units formed by another method, for example, a synthetic method, as long as they have the same structures as the structural units formed by radical polymerization.

Non-limiting examples of the structural units in the polymer obtained by radically polymerizing the polymerizable composition containing the polymerizable compound (A) and the 2-oxymethyl acrylic acid ion include (i) a structural unit in which at least one carbon-carbon double bond in the polymerizable compound (A) is replaced with a carbon-carbon single bond and a structural unit in which at least one carbon-carbon double bond in the 2-oxymethyl acrylic acid ion is replaced with a carbon-carbon single bond, and (ii) a structural unit formed by cyclopolymerization of the polymerizable compound (A) and a structural unit formed by cyclopolymerization of the 2-oxymethyl acrylic acid ion when the polymerizable compound (A) and the 2-oxymethyl acrylic acid ion are each a cyclopolymerizable compound.

An example of the compound containing the 2-oxymethyl acrylic acid ion is the above-described polymerizable salt compound (B).

### <Application of Radically Polymerizable Composition of the Present Disclosure>

The radically polymerizable composition of the present disclosure can be made into a liquid state that can be applied to various printing applications by adjusting the types and amounts of the polymerizable compound (A), the polymerizable salt compound (B), and a different component. The polymer obtained from the composition can exhibit various excellent properties of conventional ionomers, and can be applied to various applications, such as various coatings (anti-crack coatings for brittle films, protective coatings for decorative films, phase difference adjustment coatings, etc.), primers, sealants, adhesives, sealing materials, pressure sensitive adhesives, various types of three-dimensional modeling (inkjet, SLA, and DLP), thermoplastic molding, thermosetting molding, hot melt adhesives, optical films, lenses, electronic components, prepregs, dental materials, paints, printing inks, fiber treatment agents, and resist materials for microfabrication.

### EXAMPLES

The present disclosure will be described in more detail below with reference to examples. The present disclosure is not limited to these examples. It should be noted that the terms “part(s)” and “%” refer to “part(s) by mass” and “% by mass”, respectively, unless otherwise stated.

### <2-Allyloxymethyl Acrylic Acid>

2-Allyloxymethyl acrylic acid with a purity of 96.5% was prepared containing 0.04% (based on the total amount of the liquid) of hydroquinone monomethyl ether and 0.06% (based on the total amount of the liquid) of 2, 2′-(ethylenedithio) diethanol as radical polymerization inhibitors. The purity was measured using the following capillary electrophoresis system.

### Measuring Apparatus

Capillary electrophoresis system Agilent 7100 (Agilent Technologies Japan, Ltd.)

### Measurement Conditions

The measurement was performed by the indirect absorption method using a background absorbent.
Capillary: Bubble cell fused-silica capillary (inner diameter 75 μm×total length 80.5 cm)
Buffer: Buffer for anion analysis (pH=8.2)
Applied voltage: −20 kV

### Quantitative Method

Quantitation was performed by the internal standard method based on the area ratio (internal standard: sodium propionate).

Preparation of reference sample: Sodium propionate and the substance to be quantified (sodium salt of carboxylate ion) were dissolved in deuterium oxide, the molar ratio was quantified by ¹H-NMR, and the solution was further diluted with ultrapure water to prepare a reference sample for constructing a calibration curve.

Preparation of measurement sample: An aqueous sodium propionate solution and a test sample were weighed and diluted with a 0.1 N aqueous sodium hydroxide solution and ultrapure water to prepare a measurement sample.

### <Dissolution of Polymerizable Salt in Water-Immiscible Radically Polymerizable Compound>

### Example 1-1

A recovery flask containing a stir bar was charged with 0.26 g of zinc oxide, 2.8 g of methanol, and 1.04 g of 2-allyloxymethyl acrylic acid in this order. The contents were stirred at 50° C. for four hours to obtain a homogeneous methanol solution (90 mol % of the 2-allyloxymethyl acrylic acid had been neutralized with the zinc). The solution was cooled to room temperature, 2.8 g of 2-ethylhexyl acrylate was added thereto, and the methanol was removed under reduced pressure with a vacuum pump while the solution was kept at room temperature. Even after removing the methanol, the contents remained a homogeneous, transparent liquid (zinc concentration: 5.2%). Table 1 shows the results.

### Example 1-2

A homogeneous, transparent liquid composition having a zinc concentration of 5.2% was obtained as in Example 1-1, except that 2-ethylhexyl acrylate was changed to cyclohexyl acrylate. Table 1 shows the results.

### Comparative Example 1-1

A recovery flask containing a stir bar was charged with 0.22 g of zinc oxide, 2.8 g of methanol, and 0.43 g of acrylic acid in this order. The contents were stirred at 50° C. for four hours to obtain a homogeneous methanol solution (90 mol % of the acrylic acid had been neutralized with the zinc). The solution was cooled to room temperature, 2.8 g of 2-ethylhexyl acrylate (an amount that allows the zinc concentration to be 5.2% after the methanol was removed) was added thereto, and the methanol was removed under reduced pressure with a vacuum pump while the solution was kept at room temperature. During the removal of the methanol, a white precipitate was formed, failing to obtain a homogeneous solution. Table 1 shows the results.

### Comparative Example 1-2

The same procedure as in Comparative Example 1-1 was performed except that 2-ethylhexyl acrylate was changed to cyclohexyl acrylate. During the removal of the methanol, a white precipitate was formed, failing to obtain a homogeneous solution. Table 1 shows the results.

TABLE 1

| | | Exam- | Exam- | Comparative | Comparative |
|---|---|---|---|---|---|
| | | ple 1-1 | ple 1-2 | Example 1-1 | Example 1-2 |
| Weight | EHA | 70 | | 82.3 | |
| ratio | CHA | | 70 | | 82.3 |
| | AIO-A | 2.5 | 2.5 | | |
| | AIO-Zn | 27.5 | 27.5 | | |
| | AA | | | 1.3 | 1.3 |
| | AA-Zn | | | 16.4 | 16.4 |
| | AIO- | 22.3 | 22.3 | | |

| Zinc concentration [%] | 5.2 | 5.2 | 5.2 | 5.2 |
|---|---|---|---|---|
| State of mixture | Homo- | Homo- | Inhomo- | Inhomo- |
| | geneous | geneous | geneous | geneous |
| | | | (Cloudy) | (Cloudy) |

EHA 2-ethylhexyl acrylate
CHA cyclohexyl acrylate
AIO-A 2-allyloxymethyl acrylic acid
AIO-Zn zinc 2-allyloxymethyl acrylate
AA acrylic acid
AA-Zn zinc acrylate
AIO-2-allyloxymethyl acrylic acid ion

### <Properties of Polymer: Adhesion>

### Example 2-1

A recovery flask containing a stir bar was charged with 0.29 g of zinc oxide, 2.4 g of ethanol, and 1.05 g of 2-allyloxymethyl acrylic acid in this order. The contents were stirred at 50° C. for four hours to obtain a homogeneous ethanol solution (100 mol % of the 2-allyloxymethyl acrylic acid had been neutralized with the zinc). The solution was cooled to room temperature, 1.24 g of 2-ethylhexyl acrylate and 0.07 g of 1-hydroxycyclohexyl phenyl ketone were added thereto, and the contents were mixed with stirring to obtain an ethanol solution composition containing 50% of the polymerizable components.

Using a bar coater No. 4, the obtained composition was applied to a heat-resistant acrylic film (a 140 μm thick film made by melt extruding pellets obtained by the method described in Production Example 7 of JP 2019-179124 A). The workpiece was placed on a hot plate at 80° C. for five minutes for drying. The dried coating film was polymerized using a belt conveyor UV curing system (high pressure mercury lamp, illuminance: 200 mW/cm²). At a total light dose of 0.6 J/cm², the coating film became tack free.

The adhesion of the polymer layer was evaluated in accordance with JIS K 5600 May 6 (cross-cut method). Specifically, the adhesion was evaluated by the number of squares that remained without peeling or damage. Of all the squares (10×10 squares=100 squares), the number of squares that remained without peeling or damage was 100. Table 2 shows the results.

### Example 2-2

An ethanol solution composition was prepared as in Example 2-1, except that 2-ethylhexyl acrylate was changed to isobornyl acrylate. The composition was applied to a heat-resistant acrylic film and dried. The dried coating film was polymerized using a belt conveyor UV curing system. At a total light dose of 0.6 J/cm², the coating film became tack free. The polymer layer was subjected to evaluation of adhesion. The result was that the number of squares that remained without peeling or damage was 100. Table 2 shows the results.

### Example 2-3

A recovery flask containing a stir bar was charged with 0.19 g of zinc oxide, 2.4 g of ethanol, and 1.14 g of 2-allyloxymethyl acrylic acid in this order. The contents were stirred at 50° C. for three hours to obtain a homogeneous ethanol solution (60 mol % of the 2-allyloxymethyl acrylic acid had been neutralized with the zinc). The solution was cooled to room temperature, 0.75 g of cyclohexyl acrylate, 0.5 g of dipentaerythritol hexaacrylate, and 0.07 g of 1-hydroxycyclohexyl phenyl ketone were added thereto, and the contents were stirred to obtain an ethanol solution composition containing 50% of the polymerization components.

Using the composition, a dry coating film was formed on a heat-resistant acrylic film as in Example 2-1, and the dry coating film was polymerized using a belt conveyor UV curing system with a total light dose of 5 J/cm². The polymer layer was subjected to evaluation of adhesion. The result was that the number of squares that remained without peeling or damage was 100. Table 2 shows the results.

### Comparative Example 2-1

Instead of zinc 2-allyloxymethyl acrylate, 1,4-butanediol diacrylate was used which is an industrially easily available divalent acrylic acid ester, is miscible with water-immiscible radically polymerizable compounds, and is a compound having a short length between radically polymerizable groups (the length between radically polymerizable groups=the length of four carbon atoms).

In other words, 1.2 g of 1, 4-butanediol diacrylate, 1.2 g of 2-ethylhexyl acrylate, and 0.07 g of 1-hydroxycyclohexyl phenyl ketone were mixed with stirring, and the resulting homogeneous, transparent liquid composition was applied to a heat-resistant acrylic film using a bar coater No. 2. The coating film was polymerized using a belt conveyor UV curing system as in Example 2-1. At a total light dose of 5 J/cm², the coating film became tack free.

The polymer layer was subjected to evaluation of adhesion. The result was that the number of squares that remained without peeling or damage was 0. Table 2 shows the results.

### Comparative Example 2-2

A liquid composition was prepared as in Comparative Example 2-1, except that 2-ethylhexyl acrylate was changed to isobornyl acrylate. The liquid composition was applied to a heat-resistant acrylic film. The coating film was polymerized using a belt conveyor UV curing system. At a total light dose of 5 J/cm², the coating film became tack free. The polymer layer was subjected to evaluation of adhesion. The result was that the number of squares that remained without peeling or damage was 0. Table 2 shows the results.

### Comparative Example 2-3

A liquid composition was prepared as in Comparative Example 2-1, except that 0.72 g of cyclohexyl acrylate and 0.48 g of dipentaerythritol hexaacrylate were used instead of 1.2 g of 2-ethylhexyl acrylate. The liquid composition was applied to a heat-resistant acrylic film. The coating film was polymerized using a belt conveyor UV curing system with a total light dose of 5 J/cm². The polymer layer was subjected to evaluation of adhesion. The result was that the number of squares that remained without peeling or damage was 22. Table 2 shows the results.

TABLE 2

| | | Example | Example | Example | Comparative | Comparative | Comparative |
|---|---|---|---|---|---|---|---|
| | | 2-1 | 2-2 | 2-3 | Example 2-1 | Example 2-2 | Example 2-3 |
| Weight ratio | EHA | 50 | | | 50 | | |
| | IBOA | | 50 | | | 50 | |
| | CHA | | | 30 | | | 30 |
| | DPHA | | | 20 | | | 20 |
| | BDDA | | | | 50 | 50 | 50 |
| | AIO-A | | | 17.6 | | | |
| | AIO-Zn | 50 | 50 | 32.4 | | | |
| | AIO- | 40.6 | 40.6 | 26.3 | | | |

| | | | | | | |
|---|---|---|---|---|---|---|
| Adhesion | 100 | 100 | 100 | 0 | 0 | 22 |
| (squares remained) | | | | | | |

EHA 2-ethylhexyl acrylate
IBOA isobornyl acrylate
CHA cyclohexyl acrylate
DPHA dipentaerythritol hexaacrylate
BDDA 1, 4-butanediol diacrylate
AIO-A 2-allyloxymethyl acrylic acid
AIO-Zn zinc 2-allyloxymethyl acrylate
AIO-2-allyloxymethyl acrylic acid ion

### <Properties of Polymer: Tensile Properties>

### Example 3-1

A recovery flask containing a stir bar was charged with 0.12 g of zinc oxide, 3.0 g of methanol, and 1.49 g of 2-allyloxymethyl acrylic acid in this order. The contents were stirred at 50° C. for four hours to obtain a homogeneous solution (29 mol % of the 2-allyloxymethyl acrylic acid had been neutralized with the zinc). The solution was cooled to room temperature, and 3.57 g of 2-ethylhexyl acrylate was added thereto. The methanol was removed under reduced pressure with a vacuum pump while the solution was kept at room temperature. Thereafter, 0.15 g of 1-hydroxycyclohexyl phenyl ketone was added thereto and mixed with stirring to obtain a polymerizable composition as a homogeneous, transparent liquid.

A glass plate (15 cm×7 cm) with a 2 mm thick polypropylene plate attached thereto and an iron plate (15 cm×7 cm) with a 2 mm thick polypropylene plate attached thereto were placed facing each other with the polypropylene plates facing inward. A 0.5 mm thick silicone sheet cut into a U-shape was disposed between the plates as a spacer, and they were clipped together to prepare a cast molding. The polymerizable composition was poured into the cast molding and irradiated with UV light from the glass plate side using a belt conveyor UV curing system (high pressure mercury lamp, illuminance: 200 mW/cm²) until the total light dose reached 2 J/cm². The clip was removed and one of the plates was removed, and then the polymerizable composition was irradiated with UV light again until the total light dose reached 1 J/cm². The other plate and the silicone sheet were removed to obtain a sheet of approximately 13 cm×5 cm×0.5 mm in thick. The sheet was punched out into a No. 3 dumbbell-shaped test piece (in accordance with JIS K 6251) using a sample cutter.

The thickness at the center of the test piece was measured. The test piece was subjected to measurement of tensile strength (maximum tensile force until the test piece breaks), Young's modulus, and elongation at break using a tensile tester (grip distance: 60 mm, tensile speed: 10 mm/min). Table 3 shows the results.

Furthermore, the remaining portion after the preparation of the dumbbell-shaped test piece was analyzed by X-ray diffraction. The analysis showed that peak due to ion aggregate domains specific to ionomers were observed on the low angle side (20=2° to 4°).

### Example 3-2

A screw-cap tube containing a stir bar was charged with 1.42 g of 2-allyloxymethyl acrylic acid, 3.43 g of 2-ethylhexyl acrylate, and 0.10 g of tris(2-aminoethyl)amine in this order. The contents were mixed with stirring to obtain a homogeneous solution (29 mol % of the 2-allyloxymethyl acrylic acid had been neutralized with the amine). Further, 0.15 g of 1-hydroxycyclohexyl phenyl ketone was added thereto and mixed with stirring to obtain a polymerizable composition as a homogeneous, transparent liquid.

A No. 3 dumbbell-shaped test piece was prepared using the polymerizable composition as in Example 3-1 and subjected to measurement of tensile strength, Young's modulus, and elongation at break. Table 3 shows the results.

### Comparative Example 3-1

Instead of zinc 2-allyloxymethyl acrylate, 1,4-butanediol diacrylate was used which is an industrially easily available divalent acrylic acid ester, is miscible with water-immiscible radically polymerizable compounds, and is a compound having a short length between radically polymerizable groups (acryloyloxy groups) (the length between the acryloyloxy groups=the length of four carbon atoms).

In other words, 0.5 g of 1, 4-butanediol diacrylate, 4.5 g of 2-ethylhexyl acrylate, and 0.15 g of 1-hydroxycyclohexyl phenyl ketone were mixed with stirring to obtain a polymerizable composition. A No. 3 dumbbell-shaped test piece was prepared using the polymerizable composition as in Example 3-1. A tensile test was attempted but failed because the strength of the test piece was so weak that the part clamped by the grips broke when the test piece was set between the grips. Table 3 shows the results.

### Comparative Example 3-2

A polymerizable composition was obtained as in Comparative Example 3-1, except that 1.5 g of 1,4-butanediol diacrylate and 3.5 g of 2-ethylhexyl acrylate were used instead of 0.5 g of 1, 4-butanediol diacrylate and 4.5 g of 2-ethylhexyl acrylate. A No. 3 dumbbell-shaped test piece was prepared using the polymerizable composition as in Example 3-1 and subjected to measurement of tensile strength, Young's modulus, and elongation at break. Table 3 shows the results.

### Example 3-3

A recovery flask containing a stir bar was charged with 0.79 g of zinc oxide, 9.0 g of methanol, and 4.77 g of 2-allyloxymethyl acrylic acid in this order. The contents were stirred at 50° C. for four hours to obtain a homogeneous solution (60 mol % of the 2-allyloxymethyl acrylic acid had been neutralized with the zinc). The solution was cooled to room temperature, 10.44 g of 2-ethylhexyl acrylate was added thereto, and the methanol was removed under reduced pressure with a vacuum pump while the solution was kept at room temperature. Thus, about 16 g of an initiator-free polymerizable composition was obtained.

To a 5.0 g portion of the polymerizable composition was added 0.15 g of 1-hydroxycyclohexyl phenyl ketone, and they were mixed with stirring. Then, a No. 3 dumbbell-shaped test piece of the mixture was prepared as in Example 3-1 and subjected to measurement of tensile strength, Young's modulus, and elongation at break. Table 3 shows the results.

### Example 3-4

To the initiator-free polymerizable composition obtained in Example 3-3 were added 0.10 g of 1-hydroxycyclohexyl phenyl ketone and 0.05 g of t-butylperoxy-2-ethylhexanoate, followed by mixing with stirring. The mixture was poured into a cast molding prepared as in Example 3-1 and irradiated with UV light from the glass plate side using a belt conveyor UV curing system until the total light dose reached 1 J/cm². The cast molding was placed in an oven at 110° C. and heated for one hour. Thereafter, the cast molding was removed to obtain a sheet of approximately 13 cm×5 cm×0.5 mm in thick. A No. 3 dumbbell-shaped test piece of the sheet was prepared as in Example 3-1 and subjected to measurement of tensile strength, Young's modulus, and elongation at break. Table 3 shows the results.

### Example 3-5

To the initiator-free polymerizable composition obtained in Example 3-3 were added 0.10 g of t-butyl peroxypivalate and 0.05 g of 1,1-di (t-hexylperoxy)cyclohexane, followed by mixing with stirring to prepare a polymerizable composition.

Two iron plates (15 cm×7 cm) each with a 2 mm thick polypropylene plate attached thereto were placed facing each other with the polypropylene plates facing inward. A 0.5 mm thick silicone sheet cut into a U-shape was disposed between the plates as a spacer, and they were clipped together to prepare a cast molding. The polymerizable composition was poured into the cast molding, and the cast molding was then placed in a polypropylene bag. The bag was immersed in warm water at 60° C. for two hours with the bag hanging. The cast molding was placed in an oven at 110° C. and heated for one hour. Thereafter, the cast molding was removed to obtain a sheet of approximately 13 cm×5 cm×0.5 mm in thick. A No. 3 dumbbell-shaped test piece of the sheet was prepared as in Example 3-1 and subjected to measurement of tensile strength, Young's modulus, and elongation at break. Table 3 shows the results.

### Example 3-6

A polymerizable composition was obtained as in Example 3-1, except that 1.53 g of a trimethylolpropane adduct of tolylene diisocyanate was further contained. Specifically, a recovery flask containing a stir bar was charged with 0.12 g of zinc oxide, 3.0 g of methanol, and 1.49 g of 2-allyloxymethyl acrylic acid in this order. The contents were stirred at 50° C. for four hours to obtain a homogeneous solution (29 mol % of the 2-allyloxymethyl acrylic acid had been neutralized with the zinc). The solution was cooled to room temperature, 3.57 g of 2-ethylhexyl acrylate was added thereto, and the methanol was removed under reduced pressure with a vacuum pump while the solution was kept at room temperature. Then, 2.04 g of a 75% ethyl acetate solution of a trimethylolpropane adduct of tolylene diisocyanate was added, and the ethyl acetate was removed under reduced pressure with a vacuum pump while the solution was kept at room temperature. Finally, 0.15 g of 1-hydroxycyclohexyl phenyl ketone was added thereto and mixed with stirring to obtain a polymerizable composition as a homogeneous, transparent liquid.

A sheet of approximately 13 cm×5 cm×0.5 mm in thick was obtained using the polymerizable composition as in Example 3-1. The sheet was cut in half with a cutter to obtain two sheets of approximately 6.5 cm×5 cm. One of the sheets was placed in an oven at 150° C. for 30 minutes to react the carboxyl groups with the isocyanate groups, and then cooled to room temperature. The surface of the other sheet, which was unheated, was wiped with a methanol-dampened paper wipe. It became cloudy and sticky. On the other hand, when the surface of the heated sheet was wiped with a methanol-dampened paper wipe, it did not become cloudy or sticky.

TABLE 3

| | | Example | Example | Comparative | Comparative | Example | Example | Example |
|---|---|---|---|---|---|---|---|---|
| | | 3-1 | 3-2 | Example 3-1 | Example 3-2 | 3-3 | 3-4 | 3-5 |
| Weight | EHA | 70 | 70 | 90 | 70 | 66.6 | 66.6 | 66.6 |
| ratio | BDDA | | | 10 | 30 | | | |
| | AIO-A | 20 | 19.9 | | | 11.8 | 11.8 | 11.8 |
| | AIO-Zn | 10 | | | | 21.6 | 21.6 | 21.6 |
| | AIO-TAEA | | 10.1 | | | | | |
| | AIO- | 8.1 | 8.1 | | | 17.5 | 17.5 | 17.5 |
| Polymerization condition | | UV | UV | UV | UV | UV | UV + Heat | Heat |
| Tensile | Tensile strength [MPa] | 7.1 | 7.5 | Broke | 2.4 | 2.4 | 11.7 | 15.9 |
| test | Young's modulus [MPa] | 41.2 | 70.2 | between | 18.4 | 18.4 | 108.1 | 129.9 |
| | Elongation at break [%] | 449 | 512 | grips | 15 | 15 | 225 | 195 |

EHA 2-ethylhexyl acrylate
BDDA 1,4-butanediol diacrylate
AIO-A 2-allyloxymethyl acrylic acid
AIO-Zn zinc 2-allyloxymethyl acrylate
AIO-TAEA tris(2-aminoethyl)amine salt of 2-allyloxymethyl acrylic acid
AIO-2-allyloxymethyl acrylic acid ion

As is evident from the results of the tensile test of Examples 3-1 to 3-5 and Comparative Examples 3-1 and 3-2, the polymers of the present invention have excellent mechanical strength, and the result of X-ray diffraction of Example 3-1 shows that the polymer of the present invention has an ionomer structure. In addition, Example 3-6 shows that the solvent resistance can be improved by adding in advance a crosslinking agent that reacts with a carboxyl group and then performing heat curing after UV curing, that is, by employing a dual-cure system.

### <Properties of Polymer: Thermoplasticity>

### Example 4-1

A recovery flask containing a stir bar was charged with 0.12 g of zinc oxide, 3.0 g of methanol, and 1.49 g of 2-allyloxymethyl acrylic acid in this order. The contents were stirred at 50° C. for four hours to obtain a homogeneous solution (29 mol % of the 2-allyloxymethyl acrylic acid had been neutralized with the zinc). The solution was cooled to room temperature, and 3.57 g of cyclohexyl acrylate was added thereto. The methanol was removed under reduced pressure with a vacuum pump while the solution was kept at room temperature. Thereafter, 0.15 g of 1-hydroxycyclohexyl phenyl ketone was added thereto and mixed with stirring to obtain a polymerizable composition as a homogeneous, transparent liquid.

A glass plate (15 cm×7 cm) with a 2 mm thick polypropylene plate attached thereto and an iron plate (15 cm×7 cm) with a 2 mm thick polypropylene plate attached thereto were placed facing each other with the polypropylene plates facing inward. A 0.5 mm thick silicone sheet cut into a U-shape was disposed between the plates as a spacer, and they were clipped together to prepare a cast molding. The polymerizable composition was poured into the cast molding and irradiated with UV light from the glass plate side using a belt conveyor UV curing system (high pressure mercury lamp, illuminance: 200 mW/cm²) until the total light dose reached 2 J/cm². The clip was removed and one of the plates was removed, and then the polymerizable composition was irradiated with UV light again until the total light dose reached 1 J/cm². The other plate and the silicon sheet were removed to obtain a sheet of approximately 13 cm×5 cm×0.5 mm in thick. The sheet was cut with a cutter into a 10 cm×4 cm strip piece, and the edges of the piece were polished. The remaining portion after cutting out the strip piece was subjected to measurement of pencil hardness using an electric pencil hardness tester under a load of 750 g. The pencil hardness was found to be H.

Using a tensile tester equipped with an oven, the 10 cm×4 cm strip test piece was stretched at a grip distance of 60 mm, a tensile speed of 30 mm/min, and an oven temperature of 120° C. When the elongation of the test piece reached 100% (i.e., the test piece was stretched to twice its length), the stretching was stopped, the oven was removed, and the test piece was cooled to room temperature and removed from the grips. The resulting test piece was transparent.

The test piece stretched to twice its length was subjected to measurement of pencil hardness (the scratch scanning direction was perpendicular to the stretching direction). The pencil hardness was improved to 2H.

The weight ratios of the polymerization components and the results of thermoplasticity evaluation (the test piece that can be stretched to twice its length: ∘ (good), the test piece that cannot be stretched: x (poor)) are summarized in Table 4.

### Comparative Example 4-1

Instead of zinc 2-allyloxymethyl acrylate, 1,4-butanediol diacrylate was used which is an industrially easily available divalent acrylic acid ester, is miscible with water-immiscible radically polymerizable compounds, and is a compound having a short length between radically polymerizable groups (acryloyloxy groups) (the length between the acryloyloxy groups=the length of four carbon atoms).

In other words, 1.5 g of 1, 4-butanediol diacrylate, 3.5 g of cyclohexyl acrylate, and 0.15 g of 1-hydroxycyclohexyl phenyl ketone were mixed with stirring to obtain a polymerizable composition. A 10 cm×4 cm strip test piece was prepared using the polymerizable composition as in Example 4-1. The remaining portion after the preparation of the strip test piece was subjected to measurement of pencil hardness using an electric pencil hardness tester under a load of 750 g. The pencil hardness was found to be H.

Using a tensile tester equipped with an oven, the strip test piece was stretched at a grip distance of 60 mm, a tensile speed of 30 mm/min, and an oven temperature of 120° C. The test piece broke when the elongation reached 5%.

The weight ratios of the polymerization components and the results of thermoplasticity evaluation (the test piece that can be stretched to twice its length: 0 (good), the test piece that cannot be stretched: x (poor)) are summarized in Table 4.

### Example 4-2

A 10 cm×4 cm strip test piece was prepared as in Example 4-1, except that benzyl acrylate was used instead of cyclohexyl acrylate.

Using a tensile tester equipped with an oven, the strip test piece was stretched at a grip distance of 60 mm, a tensile speed of 30 mm/min, and an oven temperature of 80° C. When the elongation of the test piece reached 100% (i.e., the test piece was stretched to twice its length), the stretching was stopped, the oven was removed, and the test piece was cooled to room temperature and removed from the grips. The resulting test piece was transparent.

The test piece stretched to twice its length was subjected to measurement of retardation at a wavelength of 550 nm using RETS-100 (Otsuka Electronics Co., Ltd.), and was found to have a positive retardation of 210 nm per 100 μm thickness. The weight ratios of the polymerization components and the results of thermoplasticity evaluation (the test piece that can be stretched to twice its length: ∘ (good), the test piece that cannot be stretched: x (poor)) are summarized in Table 4.

### Comparative Example 4-2

A 10 cm×4 cm strip test piece was prepared as in Comparative Example 4-1, except that benzyl acrylate was used instead of cyclohexyl acrylate.

Using a tensile tester equipped with an oven, the strip test piece was stretched at a grip distance of 60 mm, a tensile speed of 30 mm/min, and an oven temperature of 120° C. The test piece broke when the elongation reached 5%.

The weight ratios of the polymerization components and the results of thermoplasticity evaluation (the test piece that can be stretched to twice its length: ∘ (good), the test piece that cannot be stretched: x (poor)) are summarized in Table 4.

### Example 4-3

A recovery flask containing a stir bar was charged with 0.11 g of calcium hydroxide, 3.0 g of methanol, 1.0 g of ultrapure water, and 1.51 g of 2-allyloxymethyl acrylic acid in this order. The contents were stirred at 50° C. for one hour to obtain a homogeneous solution (29 mol % of the 2-allyloxymethyl acrylic acid had been neutralized with the calcium). The solution was cooled to room temperature, and 3.53 g of cyclohexyl acrylate was added thereto. The methanol was removed under reduced pressure with a vacuum pump while the solution was kept at room temperature. Thereafter, 0.15 g of 1-hydroxycyclohexyl phenyl ketone was added thereto and mixed with stirring to obtain a polymerizable composition as a homogeneous, transparent liquid.

A 10 cm×4 cm strip test piece was prepared using the polymerizable composition as in Example 4-1. Using a tensile tester equipped with an oven, the strip test piece was stretched at a grip distance of 60 mm, a tensile speed of 30 mm/min, and an oven temperature of 120° C. When the elongation of the test piece reached 100% (i.e., the test piece was stretched to twice its length), the stretching was stopped, the oven was removed, and the test piece was cooled to room temperature and removed from the grips. The resulting test piece was transparent.

The weight ratios of the polymerization components and the results of thermoplasticity evaluation (the test piece that can be stretched to twice its length: ∘ (good), the test piece that cannot be stretched: x (poor)) are summarized in Table 4.

### Example 4-4

A recovery flask containing a stir bar was charged with 0.34 g of magnesium hydroxide, 2.0 g of methanol, 1.0 g of ultrapure water, and 1.91 g of 2-allyloxymethyl acrylic acid in this order. The contents were stirred at 50° C. for one hour to obtain a homogeneous solution. The flask was connected to a vacuum pump, and the methanol was removed. The resulting powder was washed with acetone added to the flask, and they were filtered under reduced pressure to obtain a powder. The powder was further vacuum dried at room temperature to obtain magnesium 2-allyloxymethyl acrylate powder.

A screw-cap tube containing a stir bar was charged with 0.46 g of the magnesium 2-allyloxymethyl acrylate powder, 1.08 g of 2-allyloxymethyl acrylic acid, and 0.19 g of ultrapure water. The contents were heated to 50° C. with stirring to obtain a homogeneous, transparent liquid. The liquid was cooled to room temperature, 3.50 g of cyclohexyl acrylate and 0.15 g of 1-hydroxycyclohexyl phenyl ketone were added thereto, and the contents were mixed with stirring to obtain a polymerizable composition as a homogeneous, transparent liquid.

A 10 cm×4 cm strip test piece was prepared using the polymerizable composition as in Example 4-1. Using a tensile tester equipped with an oven, the strip test piece was stretched at a grip distance of 60 mm, a tensile speed of 30 mm/min, and an oven temperature of 120° C. When the elongation of the test piece reached 100% (i.e., the test piece was stretched to twice its length), the stretching was stopped, the oven was removed, and the test piece was cooled to room temperature and removed from the grips. The resulting test piece was transparent.

The weight ratios of the polymerization components and the results of thermoplasticity evaluation (the test piece that can be stretched to twice its length: ∘ (good), the test piece that cannot be stretched: x (poor)) are summarized in Table 4.

### Example 4-5

A recovery flask containing a stir bar was charged with 0.31 g of sodium carbonate, 3.0 g of methanol, 1.0 g of ultrapure water, and 1.49 g of 2-allyloxymethyl acrylic acid in this order. The contents were stirred at 50° C. for one hour to obtain a homogeneous solution (29 mol % of the 2-allyloxymethyl acrylic acid had been neutralized with the sodium). The solution was cooled to room temperature, and 3.51 g of cyclohexyl acrylate was added thereto. The methanol was removed under reduced pressure with a vacuum pump while the solution was kept at room temperature. Thereafter, 0.15 g of 1-hydroxycyclohexyl phenyl ketone was added thereto and mixed with stirring to obtain a polymerizable composition as a homogeneous, transparent liquid.

A 10 cm×4 cm strip test piece was prepared using the polymerizable composition as in Example 4-1. Using a tensile tester equipped with an oven, the strip test piece was stretched at a grip distance of 60 mm, a tensile speed of 30 mm/min, and an oven temperature of 120° C. When the elongation of the test piece reached 100% (i.e., the test piece was stretched to twice its length), the stretching was stopped, the oven was removed, and the test piece was cooled to room temperature and removed from the grips. The resulting test piece was transparent.

The weight ratios of the polymerization components and the results of thermoplasticity evaluation (the test piece that can be stretched to twice its length: 0 (good), the test piece that cannot be stretched: x (poor)) are summarized in Table 4.

### Examples 4 to 6

A recovery flask containing a stir bar was charged with 0.11 g of calcium hydroxide, 3.0 g of methanol, 1.0 g of ultrapure water, and 1.51 g of 2-allyloxymethyl acrylic acid in this order. The contents were stirred at 50° C. for one hour to obtain a homogeneous solution (29 mol % of the 2-allyloxymethyl acrylic acid had been neutralized with the calcium). The solution was cooled to room temperature, and 2.52 g of cyclohexyl acrylate was added thereto. The methanol was removed under reduced pressure with a vacuum pump while the solution was kept at room temperature. Thereafter, 1.01 g of (3-ethyloxetan-3-yl)methyl acrylate and 0.15 g of 1-hydroxycyclohexyl phenyl ketone were added thereto and mixed with stirring to obtain a polymerizable composition as a homogeneous, transparent liquid.

A 10 cm×4 cm strip test piece was prepared using the polymerizable composition as in Example 4-1. Using a tensile tester equipped with an oven, the 10 cm×4 cm strip test piece was stretched at a grip distance of 60 mm, a tensile speed of 30 mm/min, and an oven temperature of 120° C. When the elongation of the test piece reached 100% (i.e., the test piece was stretched to twice its length), the stretching was stopped, the oven was removed, and the test piece was cooled to room temperature and removed from the grips. The resulting test piece was transparent.

The remaining portion after cutting out the strip test piece was subjected to measurement of pencil hardness using an electric pencil hardness tester under a load of 750 g. The pencil hardness was found to be H. The surface of the remaining portion was wiped with an acetone-dampened paper wipe. It became cloudy slightly. Separately, another remaining portion was heated on a hot plate at 200° C. for five minutes and subjected to measurement of pencil hardness. The pencil hardness was found to be 3H. When the surface thereof was wiped with an acetone-dampened paper wipe, it did not become cloudy.

The weight ratios of the polymerization components and the results of thermoplasticity evaluation (the test piece that can be stretched to twice its length: ∘, the test piece that cannot be stretched: x (poor)) are summarized in Table 4.

TABLE 4

| | | Example | Comparative | Example | Comparative | Example | Example | Example | Example |
|---|---|---|---|---|---|---|---|---|---|
| | | 4-1 | Example 4-1 | 4-2 | Example 4-2 | 4-3 | 4-4 | 4-5 | 4-6 |
| Weight | CHA | 70 | 70 | | | 70 | 70 | 70 | 50 |
| ratio | BZA | | | 70 | 70 | | | | |
| | OXEA | | | | | | | | 20 |
| | BDDA | | 30 | | 30 | | | | |
| | AIO-A | 20 | | 20 | | 20.5 | 20.8 | 20.4 | 20.5 |
| | AIO-Zn | 10 | | 10 | | | | | |
| | AIO-Ca | | | | | 9.5 | | | 9.5 |
| | AIO-Mg | | | | | | 9.2 | | |
| | AIO-Na | | | | | | | 9.6 | |
| | AIO- | 8.1 | | 8.1 | | 8.3 | 8.3 | 8.3 | 8.3 |

| | | | | | | | | |
|---|---|---|---|---|---|---|---|---|
| Thermoplasticity | ∘ | x | ∘ | x | ∘ | ∘ | ∘ | ∘ |

CHA cyclohexyl acrylate
BZA benzyl acrylate
OXEA (3-ethyloxetan-3-yl)methyl acrylate
BDDA 1, 4-butanediol diacrylate
AIO-A 2-allyloxymethyl acrylic acid
AIO-Zn zinc 2-allyloxymethyl acrylate
AIO-Ca 2-allyloxymethyl acrylate calcium
AIO-Mg 2-allyloxymethyl acrylate magnesium
AIO-Na sodium 2-allyloxymethyl acrylate
AIO-2-allyloxymethyl acrylic acid ion

As is evident from the results of the heat tensile test of Examples 4-1 to 4-6 and Comparative Examples 4-1 and 4-2, the polymers of the present invention are crosslinked resins, but have thermoplasticity. The result of the pencil hardness test of Example 4-1 shows that the scratch hardness is improved by heat stretching. The result of the phase difference measurement of Example 4-2 shows that phase difference is developed by heat stretching. Example 4-6 shows that heating at 120° C. enables stretching, while heating at 200° C. allows the oxetanyl groups and the carboxyl groups to react to provide a stronger crosslinked resin having better scratch hardness and solvent resistance than those before heating.

### <Properties of Polymer: Stretch Conformability>

### Example 5-1

A heat-resistant acrylic film with a protective film on one side (a 140 μm thick film made by melt extruding pellets obtained by the method described in Production Example 7 of JP 2019-179124 A, with a polyethylene protective film attached to one side of the film) was cut to 15 cm×7 cm. The protective film side was attached to an iron plate (15 cm×7 cm) with weak adhesive spray glue, and then cellophane tape (thickness 50 μm) was attached in a U-shape on the heat-resistant acrylic film. A polymerizable composition prepared as in Example 4-1 was placed on the region where the cellophane tape was not attached, and a glass plate (15 cm×7 cm) with a 2 mm thick polypropylene plate attached thereto was attached to the acrylic film with the polypropylene plate facing inward. They were clipped together while the air bubbles were removed. The polymerizable composition was irradiated with UV light from the glass plate side using a belt conveyor UV curing system (high pressure mercury lamp, illuminance: 200 mW/cm²) until the total light dose reached 2 J/cm². The glass plate and the iron plate were removed. The portion with the cellophane tape of the workpiece was cut together with the heat-resistant acrylic film, thereby obtaining a strip, heat-resistant acrylic film with one side of which being coated with the polymer of the present invention. Using a tensile tester equipped with an oven, the strip test piece was stretched at a grip distance of 60 mm, a tensile speed of 300 mm/min, and an oven temperature of 130° C. When the elongation of the test piece reached 100% (i.e., the test piece was stretched to twice its length), the stretching was stopped, the oven was removed, and the test piece was cooled to room temperature and removed from the grips. The resulting test piece was transparent and had no separation between the polymer layer and the heat-resistant acrylic film as a substrate.

The formulations of the polymerizable compositions are shown in Table 5.

### Example 5-2

A screw-cap tube containing a stir bar was charged with 0.007 g of a fluorosurfactant (Ftergent 215M, Neos Co., Ltd.), 0.14 g of zinc oxide, 1.99 g of phenoxyethyl acrylate, and 1.00 g of 2-allyloxymethyl acrylic acid. The contents were stirred at 50° C. for 30 minutes to obtain a homogeneous solution. To the solution was added 0.25 g of N,N′-bis(2-hydroxyethyl)ethylenediamine. They were stirred to obtain a homogeneous solution, which was then cooled to room temperature. Finally, 0.10 g of 1-hydroxycyclohexyl phenyl ketone was added thereto and mixed with stirring to obtain a polymerizable composition as a homogeneous, transparent liquid.

A heat-resistant acrylic film with a protective film on one side (a 140 μm thick film made by melt extruding pellets obtained by the method described in Production Example 7 of JP 2019-179124 A, with a polyethylene protective film attached to one side of the film) was cut to 15 cm×7 cm. The protective film side was attached to a glass plate (15 cm×7 cm) with weak adhesive spray glue. Thereafter, the polymerizable composition was applied to the heat-resistant acrylic film using a bar coater No. 4, and then irradiated with UV light until the total light dose reached 1 J/cm² under a nitrogen atmosphere using a belt conveyor UV curing system (high pressure mercury lamp, illuminance: 150 mW/cm²). The surface was tack free and hard.

The coating film was removed from the glass plate and both ends thereof were cut to obtain a strip, heat-resistant acrylic film (10 cm×5 cm) with one side of which being coated with the polymer of the present invention. Using a tensile tester equipped with an oven, which was the same as that described above, the strip test piece was stretched at a grip distance of 60 mm, a tensile speed of 300 mm/min, and an oven temperature of 130° C. When the elongation of the test piece reached 100% (i.e., the test piece was stretched to twice its length), the stretching was stopped, the oven was removed, and the test piece was cooled to room temperature and removed from the grips. The resulting test piece was transparent and had no separation between the polymer layer and the heat-resistant acrylic film as a substrate.

The formulations of the polymerizable compositions are shown in Table 5.

### Example 5-3

A screw-cap tube containing a stir bar was charged with 0.009 g of a fluorosurfactant (Ftergent 215M, Neos Co., Ltd.), 0.22 g of zinc oxide, 2.80 g of phenoxyethyl acrylate, 0.80 g of 2-allyloxymethyl acrylic acid, and 0.39 g of acrylic acid. The contents were stirred at 50° C. for 30 minutes to obtain a homogeneous solution. After the temperature was returned to room temperature, 0.53 g of diallylamine was added and stirred, and finally 0.14 g of 1-hydroxycyclohexyl phenyl ketone was added thereto and mixed with stirring to obtain a polymerizable composition as a homogeneous, transparent liquid.

A heat-resistant acrylic film with a protective film on one side (a 140 μm thick film made by melt extruding pellets obtained by the method described in Production Example 7 of JP 2019-179124 A, with a polyethylene protective film attached to one side of the film) was cut to 15 cm×7 cm. The protective film side was attached to a glass plate (15 cm×7 cm) with weak adhesive spray glue. Thereafter, the polymerizable composition was applied to the heat-resistant acrylic film using a bar coater No. 4, and then irradiated with UV light until the total light dose reached 1 J/cm² under a nitrogen atmosphere using a belt conveyor UV curing system (high pressure mercury lamp, illuminance: 150 mW/cm²). The surface was tack free and hard.

The coating film was removed from the glass plate and both ends thereof were cut to obtain a strip, heat-resistant acrylic film (10 cm×5 cm) with one side of which being coated with the polymer of the present invention. Using a tensile tester equipped with an oven, which was the same as that described above, the strip test piece was stretched at a grip distance of 60 mm, a tensile speed of 300 mm/min, and an oven temperature of 130° C. When the elongation of the test piece reached 100% (i.e., the test piece was stretched to twice its length), the stretching was stopped, the oven was removed, and the test piece was cooled to room temperature and removed from the grips. The resulting test piece was transparent and had no separation between the polymer layer and the heat-resistant acrylic film as a substrate.

The formulations of the polymerizable compositions are shown in Table 5.

TABLE 5

| | | | Example | | |
|---|---|---|---|---|---|
| | | | 5-1 | 5-2 | 5-3 |
| Weight | Anion | 2-Allyloxymethyl acrylic | 8.1 | 28.9 | 16.5 |
| ratio of | | acid ion | | | |
| component | | Acrylic acid ion | — | — | 8.3 |
| | Cation | Zinc ion | 1.9 | 3.4 | 3.8 |
| | | Protonated N,N′-bis(2- | — | 7.7 | — |
| | | hydroxyethyl) | | | |
| | | ethylenediamine | | | |
| | | Protonated diallylamine | — | — | 11.4 |

| | | | |
|---|---|---|---|
| 2-Allyloxymethyl acrylic acid | 20.0 | — | — |
| Cyclohexyl acrylate | 70.0 | — | — |
| Phenoxyethyl acrylate | — | 60.0 | 60.0 |
| Fluorosurfactant | — | 0.2 | 0.2 |
| 1-Hydroxycyclohexyl phenyl ketone | 3.0 | 3.0 | 3.0 |

The stretch conformability of Examples 5-1 to 5-3 utilizes the adhesion of the polymers of the present invention, which is evident from Examples 2-1 to 2-3, and the thermoplasticity of the polymers of the present invention, which is evident from Examples 4-1 to 4-6. In other words, this indicates that the coating layer laminated on the substrate is a crosslinked resin, but can be thermoformed integrally with the substrate. Therefore, the polymerizable composition of the present invention can be used, for example, for a crack prevention coating for a fragile raw film, a protective coating for a decorative film, a retardation adjustment coating, etc.

1. A radically polymerizable composition comprising:
a water-immiscible radically polymerizable compound (A); and
an anion represented by the following formula (1): 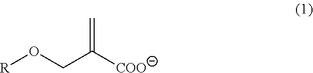
wherein R represents a saturated or unsaturated hydrocarbon group having 10 or less carbon atoms,
the anion being contained in a ratio of 1 to 120 parts by mass per 100 parts by mass of the water-immiscible radically polymerizable compound (A).

2. The radically polymerizable composition according to claim 1,
wherein R in the formula (1) is an allyl group or a methallyl group.

3. The radically polymerizable composition according to claim 1, further comprising a cation,
wherein the cation comprises one or more cations selected from the group consisting of metal ions, metal oxide ions, and cations containing non-metallic elements of Group 15 of the periodic table.

4. A polymer obtained from the radically polymerizable composition according to claim 1.
